(19) United States
(12) Patent Application Publication
(10) Pub. No.: US 2017/0351978 A1
(43) Pub. Date: Dec. 7, 2017

(54) DYNAMIC RECOMMENDATION PLATFORM WITH ARTIFICIAL INTELLIGENCE

(71) Applicant: SWIFT TRAVEL SERVICES, LLC, Santa Barbara, CA (US)

(72) Inventor: Gregory M. BELLOWE, Santa Barbara, CA (US)

(21) Appl. No.: 15/684,871

(22) Filed: Aug. 23, 2017

Related U.S. Application Data
(63) Continuation-in-part of application No. 14/073,527, filed on Nov. 6, 2013, now abandoned.

(51) Int. Cl. G06Q 10/02; G06Q 10/00; G06Q 50/00; H04L 29/08

(52) U.S. Cl. CPC G06Q 10/025; H04L 67/22; G06Q 10/30; G06Q 50/01

(57) ABSTRACT

A method and system having an artificial intelligence component which can generate recommendations to a user and/or a plurality of users. The recommendations can be based on information collected from a plurality of devices, sensors, historical usage patterns, predicted user schedules, and/or external data sources. Some embodiments include the method and system that dynamically display the actual carbon impact and/or predicted carbon impact for each item on the user's daily schedule.

### CROSS REFERENCE TO RELATED APPLICATION

This application is a continuation-in-part of U.S. patent application Ser. No. 14/073,527, filed Nov. 6, 2013, and the subject matter thereof is incorporated herein by reference in its entirety.

### TECHNICAL FIELD

The disclosure relates to a method and system having artificial intelligence component which can generate recommendations to a user and/or a plurality of users. The recommendations can be based on information collected from a plurality of devices, sensors, historical usage patterns, predicted user schedules, and/or external data sources. The disclosure relates to determining a carbon footprint for a variety of types of trip-related activities. More particularly, the invention relates to a method and system for an overall carbon impact and corresponding offset for particular entire trip itinerary.

### BACKGROUND

A carbon impact of an activity, also referred to as the activity's carbon footprint, refers to the amount of CO₂ gas that is emitted into the Earth's atmosphere as a byproduct of the activity. To assess an overall carbon impact for a set of activities, at least two aspects must be determined: what the activity is and how much carbon did the activity produce. Once an activity is identified, then steps may be taken to assess the carbon impact of that activity.

Regarding determining the carbon impact of a trip-related activity, data is being collected and made available regarding the amount of carbon emissions produced by various transportation options such as automobiles, busses, subway, trains, airplanes, and cruise ships. Some data is also collected about lodging stays. Such emissions data may be expressed in units of tons of CO₂ emissions per mile per person. Applications are now evolving that make use of this data for allowing commuters and travelers to lessen their carbon impact by choosing modes of transportation or routes that emit less carbon or pay a carbon offset fee to counter the carbon impact.

With cap and trade policies under discussion, there is a need to be able to quantify the carbon impact of various activities and to assign a monetary value to such impact. A carbon offset fee may fund organizations that create, finance, run, and/or market projects that aim to reduce greenhouse gas (GHG) emissions. One example of such a project is one that plants trees. For another example, several projects exist that collect biogas and burn it instead of burning fossil fuels to create electricity for export to the regional power grid via an interconnection with the local electric power distribution utility to generate electricity. Other projects may include buying up forested land for preservation or occupied land for clearing and planting (unpaving paradise).

Most applications use published carbon emissions data to determine a carbon footprint for transportation. That is, known applications are limited to determining a route and mode of transportation for getting from point A to point B with the smallest carbon footprint.

Carbon calculators are available on certain travel-related websites, such as United.com. FIG. 1 shows the result of using United's Carbon Offset Program in which a traveler enters the number of passengers, the month of the year and the set of cities visited. United's calculator determines a carbon offset only for that flight itinerary, and the website presents options for where to pay the offset amount. In the example shown in FIG. 1, 2 passengers travel from San Jose to Boston, creating 1.21 metric tons of CO₂. The traveler has opted to contribute $22.42 to Forest Conservation of California to offset the carbon impact of the flight. However, to determine an offset for an entire trip itinerary, separate calculators would need to be used for each individual trip event such as for hotels, meals, and activities.

Other carbon calculators available through the Internet such as myfootprint.org are directed at determining the carbon footprint of a household over a year's time. The inputs are household, not travel-related, and are not constrained to a particular start date and end date such as with a trip.

Certain tour operators build in the carbon impact offset in the price of their services. Such a tour is carbon neutral because the cost of offsetting the carbon emissions is included in the price of the tour. However, the portion of the overall cost used as an offset may not be visible to the traveler, and may only offset the portions of trip included in the tour cost. For example, flying to and from a point of departure/arrival may not be offset if the tour does not include the airfare.

### SUMMARY

Some of subject matter described herein also includes a method comprising method comprising: providing a plurality of sensors, each sensor detecting in real time one of a plurality of different real world activities and generating sensor signals therefrom indicative of said plurality of different real world activity engaged in by a user, said real world activities having an associated carbon footprint impact; a processor receiving said sensor signals from each of said plurality of sensors and generating a user profile therefrom indicative of carbon footprint impact for each of said real world activities; said processor communicatively coupling said sensor signals from each of said plurality of sensors to a central hub configured to communicate with a user device associated with the user, the plurality of sensors being in an environment associated with the user; said processor using said user profile to identify a matching cluster for the user profile having characteristics similar to characteristics associated with other user profiles within said cluster; said processor receiving a threshold time period and a carbon footprint goal representing a maximum acceptable carbon footprint impact for the user within the threshold time period; said processor determining a user schedule within the threshold time period based on the sensor signals received from the plurality of sensors and further based upon calendar data associated with the user, wherein the user schedule includes a plurality of said real world activities engaged in by the user; said processor using said other user profiles within said cluster to generate a data model representing relationships between the sensor signals received from sensors, and the real world activities performed by users; said processor identifying a total predicted carbon footprint for the user schedule based on all of the sensor signals generated by said real world activities within the threshold time period, the data model, and a predicted carbon footprint for each of the said real world activities of the user schedule; said processor determining when the total predicted carbon footprint is greater than the carbon footprint goal; said processor identifying a task which represents a user action that is taken in connection with said real world activities of the user within the user schedule, wherein the task when performed causes the total predicted carbon footprint to decrease, and wherein determining the task includes analyzing all of the user schedule, the predicted carbon footprint for each of said real world activities of the user schedule, and the sensor signals received from the plurality of sensors; and said processor communicating said task to the user device via the central hub.

Some of the subject matter disclosed herein includes a system comprising: a processor; and a memory storing instructions, wherein the processor is configured to execute the instructions such that the processor and memory are configured to: provide a plurality of sensors, each sensor detecting in real time one of a plurality of different real world activities and generating sensor signals therefrom indicative of said plurality of different real world activity engaged in by a user, said real world activities having an associated carbon footprint impact; receive said sensor signals from each of said plurality of sensors and generating a user profile therefrom indicative of carbon footprint impact for each of said real world activities; communicatively couple said sensor signals from each of said plurality of sensors to a central hub configured to communicate with a user device associated with the user, the plurality of sensors being in an environment associated with the user; identify, using said user profile, a matching cluster for the user profile having characteristics similar to characteristics associated with other user profiles within said cluster; receive a threshold time period and a carbon footprint goal representing a maximum acceptable carbon footprint impact for the user within the threshold time period; determine a user schedule within the threshold time period based on the sensor signals received from the plurality of sensors and further based upon calendar data associated with the user, wherein the user schedule includes a plurality of said real world activities engaged in by the user; generate, using said other user profiles within said cluster, a data model representing relationships between the sensor signals received from sensors, and the real world activities performed by users; identify a total predicted carbon footprint for the user schedule based on all of the sensor signals generated by said real world activities within the threshold time period, the data model, and a predicted carbon footprint for each of the said real world activities of the user schedule; determine when the total predicted carbon footprint is greater than the carbon footprint goal; identify a task which represents a user action that is taken in connection with said real world activities of the user within the user schedule, wherein the task when performed causes the total predicted carbon footprint to decrease, and wherein determining the task includes analyzing all of the user schedule, the predicted carbon footprint for each of said real world activities of the user schedule, and the sensor signals received from the plurality of sensors; and communicate said task to the user device via the central hub.

Some of the subject matter disclosed herein includes a method comprising: generating a user profile indicative of characteristics associated with a user by implementing a central hub configured to communicate with a plurality of devices associated with the user and a user's environment, the plurality of devices including a lighting device in the user's environment, a mobile user device having access to a calendar of the user and communicatively coupled to a global positioning system (GPS) indicating a location of the mobile user device, and an automobile device communicatively coupled to an automobile; receiving one or more calendar events indicating a schedule of the user; receiving from the plurality of devices a carbon footprint impact data including a timestamp and a status associated with the lighting device wherein the status includes an on status, or an off status, a geographical location associated with the GPS indicating a location of the user, and an automobile status including one or more of average speed for a time period, distance driven on a trip, vehicle location, driving habits, an automobile battery use, or throttle status; identifying a cluster for the user profile representing a similarity to other user profiles in the cluster, wherein the cluster is identified by a similarity of characteristics associated with the user profile in relation to the other user profiles; receiving a threshold time period and a carbon footprint goal representing a maximum carbon footprint impact which the user is willing to cause within the threshold time period; determining historical usage patterns based on the carbon footprint impact data representing a prior carbon footprint impact of the user; determining an anticipated carbon footprint impact based on the historical usage patterns, the one or more calendar events within the threshold time period, and the carbon footprint impact data within the threshold time period; determining that the anticipated carbon footprint impact is greater than the carbon footprint goal; providing a recommendation to the user indicating a suggestion to change a user's behavior to lower the anticipated carbon footprint impact; receiving from the plurality of devices a second carbon footprint impact data including a second timestamp and the associated one or more of a second status of the lighting device, a second geographical location associated with the GPS indicating a second location, or a second automobile status; determining a second anticipated carbon footprint impact based on the historical usage patterns, the one or more calendar events within the threshold time period, the carbon footprint impact data within the threshold time period, and the second carbon footprint impact data; determining that the anticipated carbon footprint impact is less than the carbon footprint goal; receiving from the plurality of devices a third carbon footprint impact data including a third timestamp and the associated one or more of a third status of the lighting device, a third geographical location associated with the GPS indicating a third location, or a third automobile status; determining a final carbon footprint impact upon an end of the threshold time period, wherein the final carbon footprint impact is determined by analyzing impact data carbon footprint impact data within the threshold time period, the second carbon footprint impact data, and the third carbon footprint impact data within the threshold time period; providing the user with an option to pay the final carbon footprint impact representing an action to perform to offset the final carbon footprint impact, the option including one or more of: providing an advertisement; providing a payment recommendation to pay the final carbon footprint impact to an organization based on the cluster with which the user is associated; or providing a second payment recommendation to pay the final carbon footprint impact to a second organization based on a previous offset payment activity of the user.

Some of subject matter described herein also includes a method comprising: generating a user profile indicative of characteristics associated with a user by implementing a central hub configured to communicate with a plurality of devices associated with the user and a user's environment, the plurality of devices including a lighting device in the user's environment, and a mobile user device having access to a calendar of the user and communicatively coupled to a global positioning system (GPS) indicating a location of the mobile user device; receiving one or more events indicating a schedule of the user; receiving from the plurality of devices a carbon footprint impact data including a timestamp and a status associated with the lighting device wherein the status includes an on status, or an off status, and a geographical location associated with the GPS indicating a location of the user; receiving a threshold time period and a carbon footprint goal representing a maximum carbon footprint impact which the user is willing to cause within the threshold time period; determining historical usage patterns based on the carbon footprint impact data representing a prior carbon footprint impact of the user; determining an anticipated carbon footprint impact based on the historical usage patterns, the one or more events within the threshold time period, and the carbon footprint impact data within the threshold time period; determining that the anticipated carbon footprint impact is greater than the carbon footprint goal; and providing a recommendation to the user indicating a suggestion to change a user's behavior to lower the anticipated carbon footprint impact.

Some of subject matter described herein also includes a system, comprising: a processor; and a memory storing instructions, wherein the processor is configured to execute the instructions such that the processor and memory are configured to: generate a user profile indicative of characteristics associated with a user by implementing a central hub configured to communicate with a plurality of devices associated with the user and a user's environment, the plurality of devices including a lighting device in the user's environment, and a mobile user device having access to a calendar of the user and communicatively coupled to a global positioning system (GPS) indicating a location of the mobile user device; receive one or more events indicating a schedule of the user; receive from the plurality of devices a carbon footprint impact data including a timestamp and a status associated with the lighting device wherein the status includes an on status, or an off status, and a geographical location associated with the GPS indicating a location of the user; receive a threshold time period and a carbon footprint goal representing a maximum carbon footprint impact which the user is willing to cause within the threshold time period; determine historical usage patterns based on the carbon footprint impact data representing a prior carbon footprint impact of the user; determine an anticipated carbon footprint impact based on the historical usage patterns, the one or more events within the threshold time period, and the carbon footprint impact data within the threshold time period; determine that the anticipated carbon footprint impact is greater than the carbon footprint goal; and provide a recommendation to the user indicating a suggestion to change a user's behavior to lower the anticipated carbon footprint impact.

Some of subject matter described herein also includes a device for environmental footprint offset determination comprising: an interactive user interface displaying, via a processor, environmental impact associated with a received trip itinerary having a plurality of events and at least one traveler, and at least two event types of transportation, lodging, meals and recreation; a processor collecting electronically determined location data; a processor collecting social media data associated with the traveler; a processor updating the trip itinerary using the electronically determined location data, and social media data; a processor determining a start location or an end location of the trip, updating the trip itinerary to include a transportation event to the start location or the end location; a local database storing environmental impact associated with events, the local database automatically updated from an external data source with the most recent environmental impact associated with events; the user interface providing an environmental impact offset of the trip itinerary, the environmental impact offset calculated using the environmental impact of each event of the trip itinerary, and a list of alternative selectable events having a lower environmental impact than the events associated with the itinerary.

Some of subject matter described herein also includes a device for environmental footprint offset determination comprising: an interactive user interface displaying, via a processor, environmental impact associated with a received trip itinerary having a plurality of events and at least one traveler, the events including at least two event types of transportation, lodging, meals and recreation; a processor collecting electronically determined location data; a processor collecting social media data associated with the traveler; a processor updating the trip itinerary using the electronically determined location data, and social media data; a processor determining a start location or an end location of the trip, updating the trip itinerary to include a transportation event to the start location or the end location; the processor collecting environmental impact associated an event on the itinerary from an energy consumption interface and updating the environmental impact associated with the event in a local database; the local database storing environmental impact associated with events, the local database automatically updated from an external data source with the most recent environmental impact associated with events; the determining an environmental impact offset of the trip itinerary, the environmental impact offset calculated using the environmental impact of each event of the trip itinerary; and displaying on a user interface the environmental impact offset of the trip itinerary.

Some of subject matter described herein also includes a computer-implemented method for offsetting an environmental impact of a trip comprising: displaying on an interactive user interface, an environmental impact associated with a received trip itinerary having a plurality of events and at least one traveler, the events including at least two event types of transportation, lodging, meals and recreation; collecting electronically determined location data; collecting social media data associated with the traveler; updating the trip itinerary using the electronically determined location data, and social media data; determining a start location or an end location of the trip, updating the trip itinerary to include a transportation event to the start location or the end location; storing in a local database an environmental impact associated with events, the local database automatically updated from an external data source with the most recent carbon impact associated with events; the determining an environmental impact offset of the trip itinerary, the environmental impact offset calculated using the environmental impact of for each event of the trip itinerary; and displaying on a user interface the environmental impact offset of the trip itinerary.

Some of subject matter described herein also includes a An apparatus for compensating for environmental impact associated with a trip comprising: an input device coupled to a processor receiving an environmental impact associated with a trip itinerary having a plurality of events and at least one traveler, the events including at least two event types of transportation, lodging, meals and recreation; a processor collecting electronically determined location data; a processor collecting social media data associated with the traveler; a processor updating the trip itinerary using the electronically determined location data and social media data; a processor determining a start location or an end location of the trip, updating the trip itinerary to include a transportation event to the start location or the end location; storage coupled to a processor storing a local database having an environmental impact associated with events, the local database automatically updated from an external data source with the most recent environmental impact associated with events; a processor determining an environmental impact of each event of the trip itinerary; and a display displaying the environmental impact offset of the trip itinerary.

There is much concern about environmental degradation and the impact by humans on the environment including water pollution, air pollution, land pollution, and global warming of the Earth caused by increasing concentrations of greenhouse gases produced by human activities such as the burning of fossil fuels and deforestation. Greenhouse gases typically include carbon dioxide (CO₂) and methane (CH4). The invention comprises a method and system that allows a traveler to receive feedback regarding the total adverse effect on the environment of all planned or completed activities associated with an entire trip including the impact of types of activities such as transportation, lodging, restaurants, and activities. It further allows the traveler to offset the trip's adverse impact by donating a dollar amount to an organization associated with improving the environment in ways that work to overcome the adverse effects. For example, the method and system may provide a traveler feedback on the carbon impact associated with a trip, and allow donating money to environmental organizations that work to directly to remove the CO₂ emitted as a result of the trip, such as funding the Nature Conservancy's work to plant trees or to indirectly avoid the emission of CO₂ by investing in alternative energy sources such as windmill or solar farms.

### BRIEF DESCRIPTION OF THE DRAWINGS

FIG. 1 is an example screenshot of a website providing carbon footprint information and accepting monetary carbon offsets for air transportation.

FIG. 2 is a block diagram of components of the system, according to an embodiment of the invention;

FIG. 3 is a screen shot of a web page for purchasing carbon offsets, according to an embodiment of the invention.

FIG. 4 shows at least a partial list of companies that certify trip-related services for sustainability, according to an embodiment of the invention.

FIG. 5 is a table of example carbon emissions provided by various sources across different trip-related services, according to an embodiment of the invention.

FIG. 6 shows a main page for a Trip Planner, according to an embodiment of the invention.

FIG. 7 shows more itinerary events in the itinerary tab, according to an embodiment of the invention.

FIG. 8 shows example contents of the offset tab, according to an embodiment of the invention.

FIG. 9 shows example contents of the offset tab after calculating the carbon offsets, according to an embodiment of the invention.

FIG. 10 shows an example screenshot showing the totals for the units of carbon offsets required to offset all activities of the entire trip, according to an embodiment of the invention.

FIG. 11 is a block diagram that illustrates a computer system 1100 upon which an embodiment of the invention may be implemented.

FIG. 12a-d are example screen shots of mobile device applications that may facilitate identifying and recording location, according to an embodiment of the invention.

FIG. 13 is a flow diagram showing the process of offsetting the environmental impact of trip, according to an embodiment of the invention.

FIG. 14 illustrates an embodiment of a carbon footprint determination.

FIG. 15 illustrates an embodiment of suggesting carbon lowering activities.

FIG. 16 demonstrates an embodiment of a process to recommend tasks to lessen the carbon footprint.

FIG. 17 demonstrates an embodiment of generating user profile clusters.

FIG. 18 illustrates an embodiment of the workflow.

FIG. 19 illustrates an embodiment of the workflow.

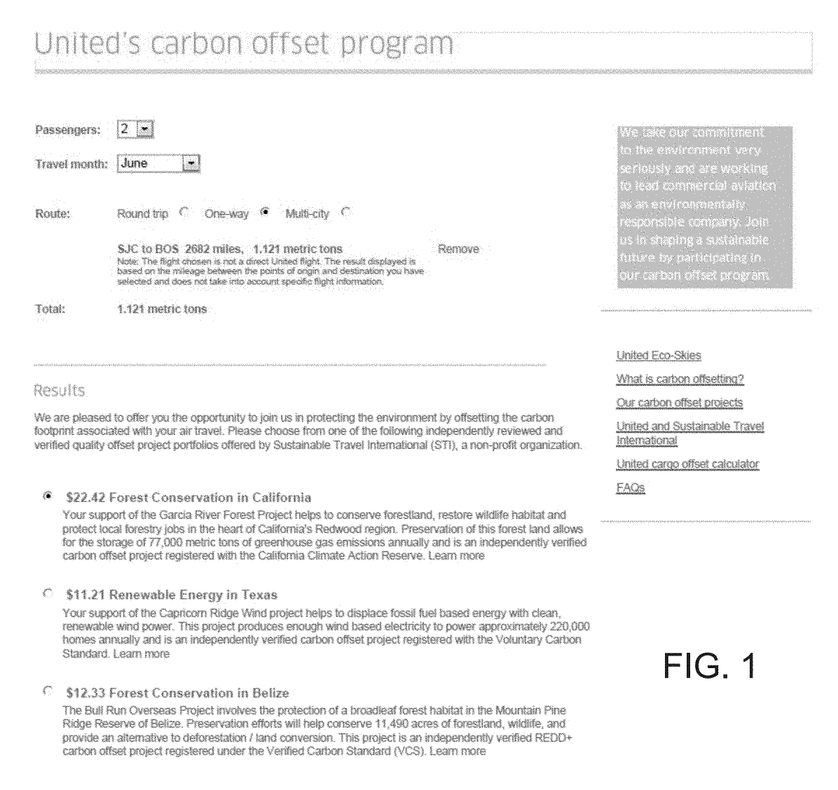

### DETAILED DESCRIPTION

The invention comprises a method and system that receive trip information including a plurality of trip events types such as transportation, lodging, meals, and other work or recreational activities, determine an estimated total environmental impact for the entire trip, such as a carbon footprint, and facilitate the payment of an offset, such as a carbon offset.

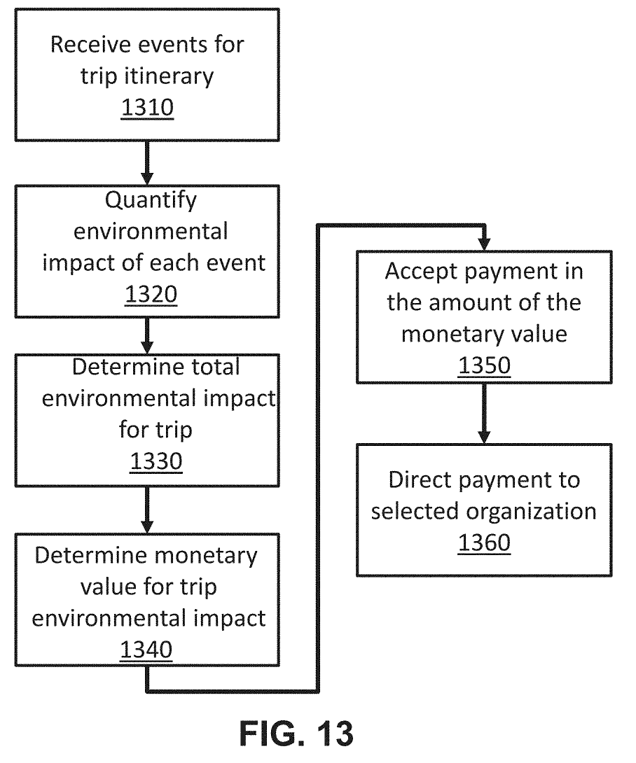

FIG. 13 is a flow diagram that provides an overview of the process for offsetting the environmental impact of a trip. In Step 1310, one or more events is received to be included in an itinerary for a trip. In Step 1320, the environmental impact of each event in the itinerary is quantified. The total environmental impact for the entire trip is determined in Step 1330, and the total trip environmental impact includes the impact of all events that were quantified in Step 1320. A monetary value is assessed for the total trip environmental impact in Step 1340, and in Step 1350, payment in the amount of the assessed monetary value is received. In Step 1360, the received payment is sent to a selected organization whose function/purpose is to ameliorate the environmental impact. The organizations may be non-profit organizations, governmental organizations, or any other kind of organization. Examples of function/purpose to ameliorate environmental impact may include planting trees, lobbying for environmental protection, buying open space as a preserve, etc.

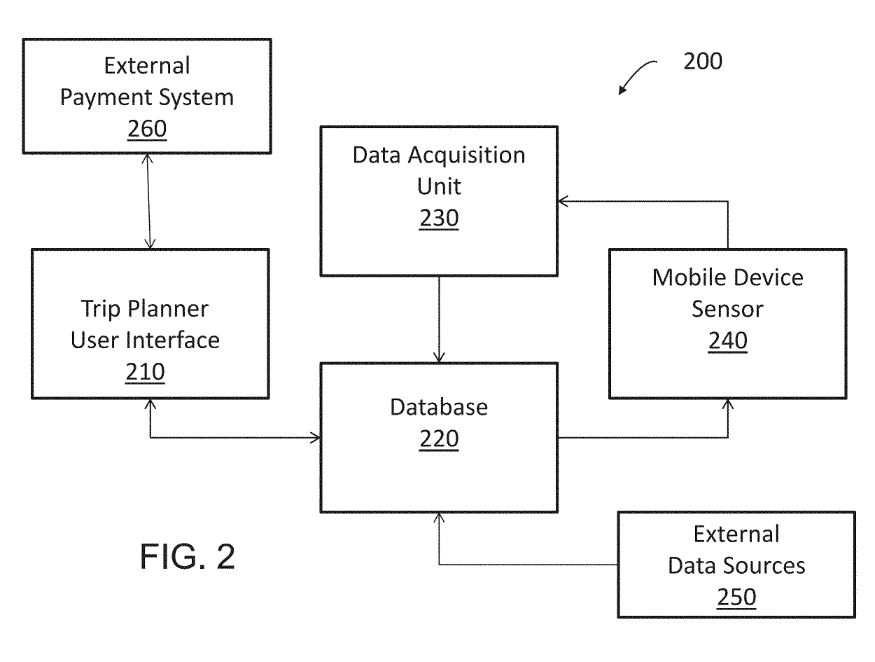

FIG. 2 is a block diagram of components of the system, according to an embodiment of the invention. System 200 shown in FIG. 2 comprises components: Trip Planner User Interface 210, Database 220, Data Acquisition Unit 230, Mobile Device Sensor and Interface 240, External Payment System 260, and External Data Sources 250. These components may each provide different capabilities in each distinct embodiment of the invention as described below.

Regarding terminology used herein, a “trip” is a well-defined sequence of activities with a known start location, optionally a start date, optionally a start time, a known end location, optionally an end date, and optionally an end time. A traveler is one who plans and takes a trip, although a person of ordinary skill in the art could imagine that a trip planner may be different than the person actually taking the trip, such as a travel agent or administrative assistant planning a business trip. We assume for simplicity herein, that the planner and the traveler are the same person, though the invention is not so limited. As such, the traveler is considered to be the user of the trip planning system.

Although the trip planning tool may be used to measure environmental impact such as depletion of the availability of potable water, air pollution such as smoke, ozone depletion, or contributions to a landfill, the following sections describe a particular example of measuring a carbon footprint. Similarly, once a dollar value is estimated for a total adverse impact on the environment, the money may be invested in a wide variety of environmental non-profit organizations (such as the Sierra Club, World Wildlife Fund, or Ocean Conservancy) in addition to those organizations directly or indirectly for reducing greenhouse gasses in the atmosphere.

### Trip Planner User Interface 210:

The trip planner user interface is an interactive portion of the trip planning application that allows a traveler to see where he/she is on a digital map through geo-location of a device, see travel related business/events/monuments around his/her current geo-location, plan a trip, see travel related businesses/events/monuments added to his/her trip, receive impact information about a trip, and pay to offset that impact. In an embodiment of the invention, the trip planner provides trip planning services for finding and selecting trip events including transportation, lodging, meals, single day recreational experiences, and multi-day experiences at one or more destinations. A trip event comprises a single line item in a trip itinerary. Similar to other travel planning sites such as Travelocity, Orbitz, or Expedia, the trip planner may provide information regarding choices of hotels, restaurants, and local activities at a destination. Similar to other trip planning sites such as mapquest.com, Google maps, or regional mass transportation sites such as 511.org, the trip planner user interface may provide information regarding alternative forms of transportation and routes to get from one location to another. However, unlike most other sites, the trip planner user interface may provide ecologically-relevant information (when there is a source for such information) regarding each choice including the carbon footprint associated with each choice as well as general ecological certification ratings for travel-related services.

Using the data in database 220, and external data sources 250, the trip planner 210 may display impact information for each individual trip event of the itinerary including at least the selected transportation, lodging, meals, and work and recreational activities. In another aspect of the invention, a total carbon impact may be determined for the entire itinerary across trip event categories. The total carbon impact may be an estimate for a planned itinerary that may change as events in the itinerary change.

Information about a planned or retrospective itinerary may be entered by the traveler and stored in database 220 for later retrieval and update. The Trip Planner user interface may also be used to update an itinerary during or after the trip. For example, an itinerary may simply specify breakfast as a trip event, and the traveler may provide more specific information about breakfast after choices are made such as the name of the eating establishment (hereinafter “restaurant”), type of restaurant, type of food ordered. Alternatively, an itinerary event may be added or deleted. For example, if the traveler sleeps in and skips breakfast, breakfast may be removed from the itinerary and the expected carbon impact from that breakfast removed from the trip total. Similarly, a traveler who planned to hike one day (having no carbon footprint) may select a visit to a museum instead because of inclement weather. The incremental carbon impact of visiting the museum may be added to the trip total.

After the last trip event for each day is entered into the itinerary, the trip planning tool may automatically add a trip event entry for returning to the ending location for the day, such as returning from the last location visited to the hotel where the traveler is staying for the night.

After the last trip event on the last day of the trip is entered into the itinerary, the trip planning tool may automatically add a trip event entry for returning to the ending location for the trip, such as returning from the last location visited to the home where the traveler lives. Alternatively, the trip planning tool may automatically add a trip event entry for returning to the starting location where the trip began. Alternatively, the trip planning tool may automatically continue to calculate carbon emissions as the traveler continues to travel until the traveler turns off the carbon footprint calculation services.

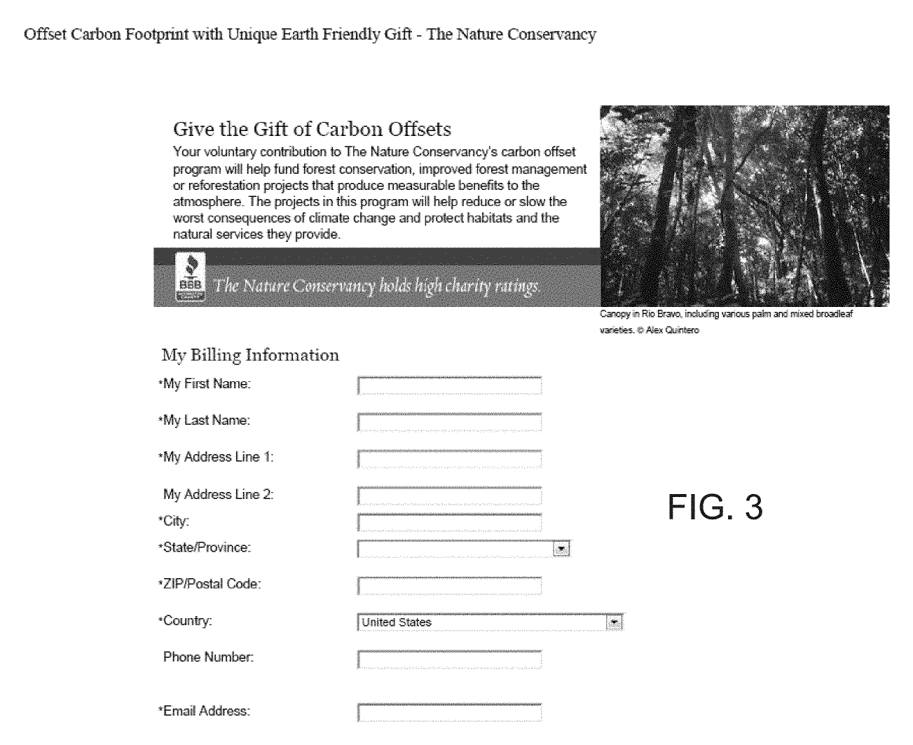

The trip planner may express the carbon impact in terms of mass (weight) of carbon dioxide per person associated with a trip event. Each trip event as well as the total carbon impact for the entire trip may also be displayed as a monetary value (e.g. dollar value) needed to offset the carbon impact of the trip. For example, planting a tree is one way to remove a certain quantity of greenhouse gases. The cost for planting the number of trees necessary to remove the amount of greenhouse gasses emitted as a result of the itinerary may be displayed. Some organizations have websites where donors can choose to offset their carbon footprint. In an embodiment of the invention, the trip planner may offer a direct link to a web site such as The Nature Conservancy (see FIG. 3) that allows donors to offset their carbon footprint by donating to reforestation efforts. In this embodiment, payment processing may be performed by the external website and the trip planner may not have access to the information regarding how much money was donated where unless and until the external website sends this information through a digital interface, email or other means. In an alternate embodiment, the trip planner may offer a list of environmental organizations, allow a traveler to select one or more of such organizations, perform payment processing (though payment processing may be outsourced), keep records of who gave how much to which organizations, and direct the traveler's donation directly to their selected organizations on behalf of the traveler. In another embodiment, rather than directly donating a traveler's money to the selected organization(s) at the time the money is received, the donated money from many travelers may be pooled over a certain period of time, then periodically, an organization may receive the total amount in the pool designated for that organization. The trip planner may keep records about and provide acknowledgements for each individual donation rather than each selected organization tracking each individual traveler's donation.

In an embodiment, the traveler may select among a number of different organizations such as an organization that plants trees or one that facilitates and supports building wind and solar generators, or alternatively the traveler may request that the trip planner distribute the donation to one or more organizations according to where the need is greatest according to the configuration of the trip planner.

Using the trip planning user interface provides a single place to make a one-time single payment for all trip events in a trip, rather than offsetting each transportation event separately from each other and from the other trip event categories. Also, In addition to planning services, the trip planner may be used to determine a retrospective carbon impact of a trip already concluded. Information regarding trip events actually concluded may be entered into the system, and a more accurate carbon impact may be determined and offset.

The trip planning user interface may run on a computer such as a desktop or laptop, but may also be run on a mobile device such as a tablet, mobile phone or other mobile devices such as google glasses. The fundamental features of planning a trip, estimating carbon footprint, determining carbon offsets, and enabling the donation of the offsets may be available on every supported device regardless of the form factor.

Checking into an itinerary event confirms attendance to the event whether pre-planned or not. Checking in can be performed using the trip planner user interface. In an alternate embodiment, a check-in application may be provided independent of the full trip planning user interface on mobile devices or on wearable devices such as watches, eyeglasses, or clothing. The wearable devices may be used to identify location, and a simplified interface for checking in may be used such detecting a voice command, a gesture, or a button tap.

Although payment for offsets is referred to herein as a “donation,” a person of ordinary skill in the art would recognize that the system described herein may also be used for paying for such offsets in exchange for some good, service, or other reward.

Database 220: Database 220 serves as a repository for account and trip information for each traveler. Account data entered through the trip planner user interface may be stored in the database in a traveler's account or used to retrieve itinerary information for a previously planned trip. As travelers interact with the planning tool, itinerary information may be stored. Travelers may also enter completed activity information to make the computed carbon impact for a trip more accurate. However, such activity completed information may also be received from other sources such as from the data acquisition unit 230.

In addition, database 220 may store data regarding potential trip events and their associated carbon impact. Data collected from external sources such as Conservation International, Carbon Fund, or the WebEx Carbon Calculator may be stored in the database and updated over time as new data becomes available or is updated.

The database may be implemented as any type of non-volatile storage with a store and retrieve interface.

Data Acquisition Unit 230: The data acquisition unit 230 may receive data from sensors that provide advisory information regarding the location and/or activities in which the traveler is engaged. An example may be a GPS unit in a traveler's mobile device or car receiving latitude and longitude identifying the location of the device. It may also be possible to gather more fine grained information about the carbon impact of an automobile trip between point A and point B from the car itself, taking into consideration driving speed, starts and stops, and elevation changes to determine and record a person's location over time, which can include information regarding a path taken, speed, and an amount of time in transit.

Applications are emerging for sensing environmental content that can capture information that could be later mined to discover a traveler's participation in an activity. For example, social media applications such as Twitter and Facebook provide a simple interface for a traveler to “check in” and report on a current activity. In an embodiment of the invention, the mobile trip planning user interface may provide such a “check in” feature.

In an embodiment, when the location data stops changing (i.e. no movement) for a threshold amount of time, the data acquisition unit may find activities related to the current location and prompt the traveler to provide updated activity information, if the traveler requests. As mobile devices become more aware of their environmental context through image and signal processing, other contextual clues could be sent to the data acquisition unit such as recognizing that the environment looks like a restaurant, hotel room, forest, amusement park, etc.

Actual information may replace the estimated data in the trip itinerary. Confirmed information such as distance based on GPS input and confirmed inferences based on contextual clues may be added to the itinerary stored in the database 220, replacing estimated data with actual data.

Mobile Device Sensor and Interface 240: The mobile device sensor and interface 240 may provide two functions. First, the display on the mobile device may be used to show the traveler information and to receive traveler input. For example, the traveler may request the system to prompt the traveler for actual activity information at a periodic interval or upon detecting an event. In addition, sensors in the mobile device may send signals to the data acquisition unit.

To obtain actual data, a traveler may authorize information to be collected from mobile phone data records and/or social media to establish where the traveler has been at various times. For example, if a traveler's location happens to coincide with the location of a hotel, the traveler may be prompted to indicate the activity associated with the location such as staying in a room there or eating in a restaurant.

Higher levels of accuracy may be associated with higher cost in terms of technology and traveler involvement. For example, a mobile phone could report location every 15 minutes or a traveler could press a button on a mobile device to cause it to report a current location when arriving at a destination.

External Data Sources 250: In an embodiment, information from external data sources 250 regarding carbon footprint associated with choices for various trip events as well as ecological certification information may be loaded into database 220 in a variety of ways. The data may be manually retrieved from the external source and formatted for the local database. Alternatively, an API may be used to periodically and automatically retrieve the most current external data for updating the local database. In another embodiment, the external sources may be searched on demand in response to a request for trip event options information.

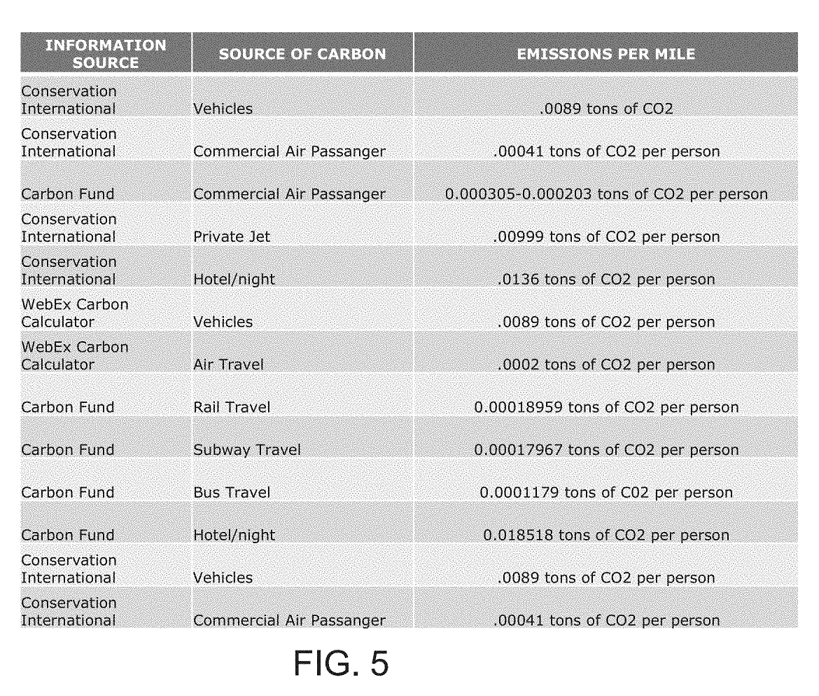

FIG. 5 is table of example carbon emissions provided by various sources across different trip-related services, according to an embodiment of the invention. The data in the table of FIG. 5 may be retrieved from various sources and stored in the database for use in computing the carbon offset of a trip. The first column of the table in FIG. 5 shows the source of the information. The second column indicates the kind of carbon source such as transportation, lodging, food, etc. Most of the information in the example tables provides carbon footprint for modes of transportation, but restaurants, lodging stays and other activities may be listed here as well.

External Payment System 260: FIG. 3 is a screen shot of a stand-alone web page for donating money to a non-profit organization whose work removes greenhouse gasses from the environment. However, this web page and those like it do not help determine how much to donate based on the carbon impact of a trip. Some other websites might help determine only a transportation carbon impact, but does not include the impact of other components of a trip.

In an embodiment, the trip planner may link directly to an established site such as the one shown in FIG. 3. In another embodiment, the trip planner may connect to and interact with an external payment system 260 for processing a credit card payments. A traveler may interact with an online payment system outsourced by a third party to deposit money in a traveler's trip planning account. The trip planning application may then transfer funds from the travelers' account to one of at least two destinations: 1) the money may be transferred directly from the traveller's account to the selected organizations providing carbon emissions offsets or 2) traveller's donations may be placed in a pool of donations to be given to the selected organization. Payments to the selected organizations may be made on a regular recurring basis. Having control over the master account or individual traveler accounts allow the host/operator of the framework to switch to paying different projects/orgs with allows us to find the best partners each year.

### Taking Instrumentation on the Road

Energy consumption information may be received by sensors in a stationary setting such as a home or business through wireless communication. Places may be instrumented to produce data in response to an individual interacting with the environment. For example, when a traveler checks into a hotel, the traveler may register with the hotel energy consumption interface. The sensors may detect the amount of electricity and hot water used in the traveler's room, and such data may be collected and provided to the traveler for inclusion in their itinerary.

### Estimating Carbon Impact

The carbon footprint estimates are based on heuristics and some related data regarding the eco-im pact of an activity.

The system may be built so that modules are plug replaceable as more information becomes available. For example, first embodiments may use a common carbon footprint estimate for eating any meal in any restaurant anywhere. Later embodiments may provide more accurate, fine-grained estimates. For example, the carbon footprint estimate may vary between a steak houses and a vegetarian restaurant, assigning a higher carbon footprint to eating in the steak house. Another example is that a different carbon footprint may be associated with eating dinner rather than breakfast. Finer grained considerations for a restaurant's carbon impact may consider eco-friendly practices such as only providing water when requested, providing small portions, using locally grown food (lowers fuel for transportation costs to the restaurant), reusing grease, or contributing compost back to a local farm. In an embodiment, the specific meal that you order may have a carbon impact associated with it that is distinguished from a different meal. For example, the carbon impact of ordering a barbecued steak may be higher than that of a raw salad.

Estimating the carbon impact of a mode of transportation such as walking, biking, automobile, bus, train, airplane, cruise ship, etc. may be determined based on the distance travelled. In an embodiment, all airline trips of a certain length may use the same carbon footprint estimate, whereas in another embodiment, different types of aircraft, how many stops are made along the route, the temperature of the locations travelled through, etc. may affect the actual carbon footprint, and may be taken into account in the carbon impact estimate.

The carbon impact for a hotel stay may be estimated as the same value for any hotel anywhere. In other embodiments, carbon impact could be differentiated based on brand/chains based on validated eco-friendly or eco- un-friendly practices, size of room, season of the stay, etc. In an embodiment, a trusted authority may assess a hotel's eco-related practices including, but not limited to: use of recycled material in building construction, use of solar electricity or solar hot water heating, providing recycling bins for guest to deposit all recyclable materials, encouraging guests to use towels and sheets more than once to reduce energy used for laundry, and use of hotel cards to enable electricity in a room such that electrical appliances are not left on when leaving the hotel with the key.

### Verifiable Source of Information for Carbon Footprint Data.

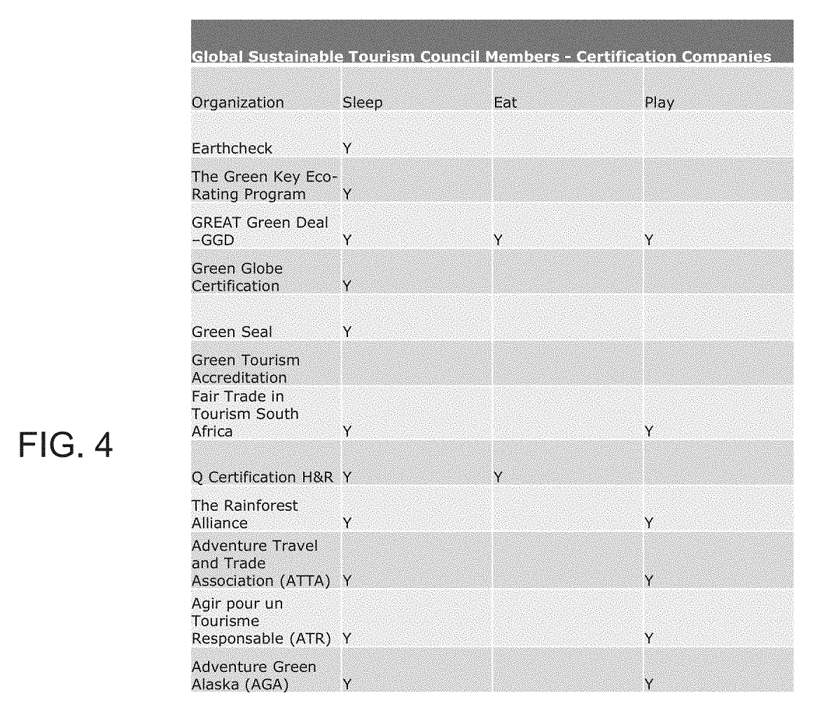

FIG. 4 shows at least a partial list of companies that certify trip-related services for sustainability. Such certification ensures that the data collected and used to estimate carbon impact has been audited and can be trusted. FIG. 4 shows organizations that audit Sleep (lodging), Eat (meals), and Play (recreation).

### Example Trip Scenarios

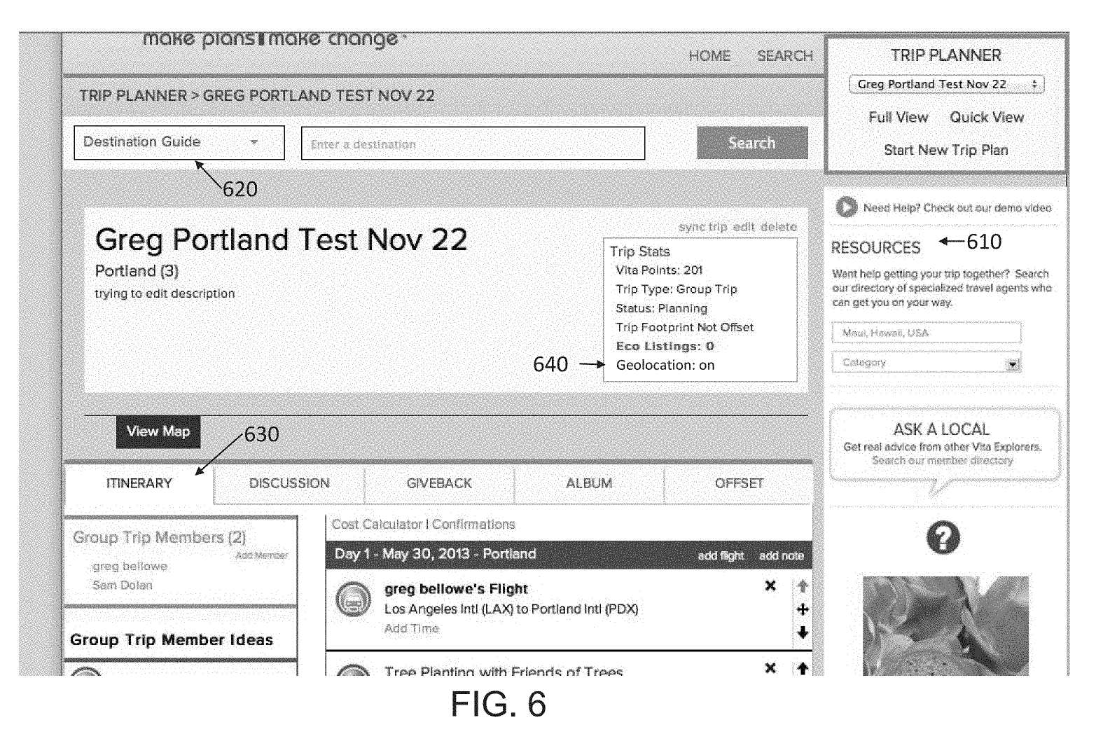

A user of the Trip Planner interface may use resources on the page or website or printed guidebook to research trip destinations. FIG. 6 shows a primary page for the Trip Planner, according to an embodiment of the invention. Resources 610 such as for finding specialized travel agents and a trip destination guide 620 shown in FIG. 6 are two examples of resources provided for trip planning. The user may start to plan a trip by selecting a destination (and other criteria through several previous steps/pages, such as number of travelers and dates of trip or number of days in trip), then search for trip ideas through the website's “Search” section and then start adding itinerary events in the Itinerary Tab 630. The Trip Stats box displays configuration information associated with the current trip. For example, a geo-location configuration 640 may be turned on or off. When turned on, the trip planner may receive location information that is generated in real-time and sent to the trip planning system by a traveler's mobile device. When turned off, the trip planner does not expect to receive such real-time location information.

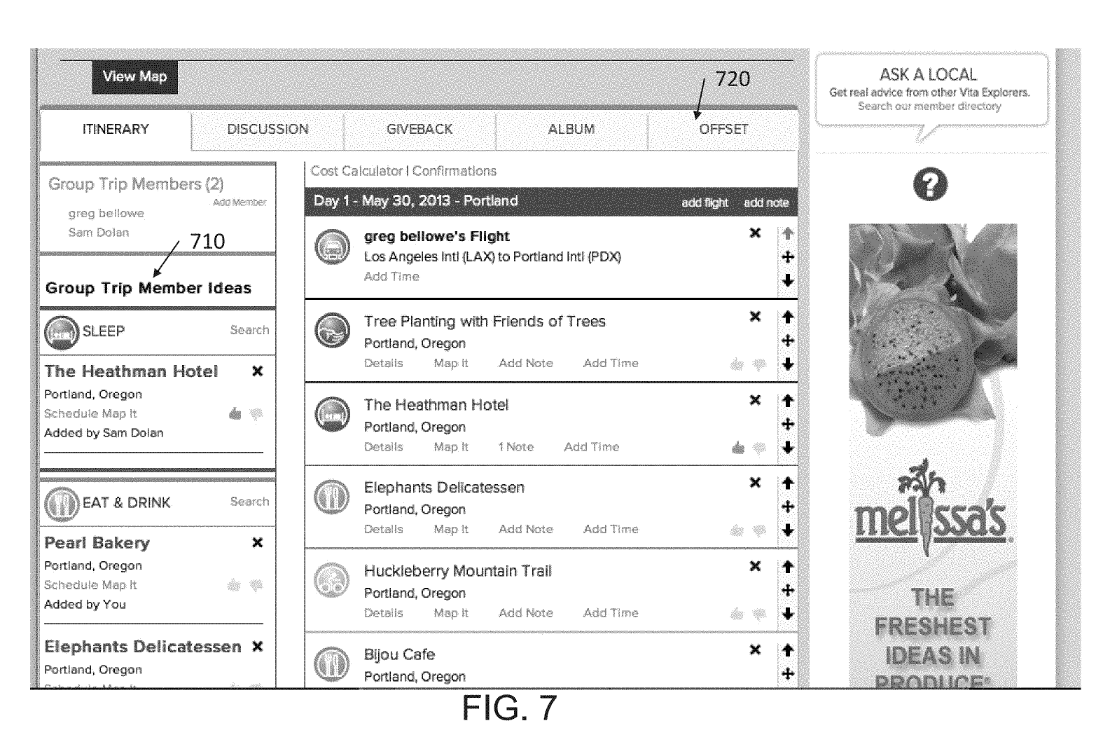

The example itinerary shown in FIG. 6 is a trip from Los Angeles to Portland planned for Greg Bellowe. FIG. 7 shows more itinerary events in the itinerary tab, according to an embodiment of the invention. For example, on May 30, 2013, Greg plans to fly from LAX to Portland International airport. In Portland, Greg will stay at the Heathman Hotel and eat at the Elephants Delicatessen and the Bijou Café. Greg plans to bicycle on the Huckleberry Mountain Trail and attend a tree planting activity. Icons next to each itinerary event correspond to the category of the event such as transportation, lodging, food, a type of activity such as biking, or a “giveback” activity having a negative carbon impact/offset (i.e. the open hand symbol).

The Group Trip Member Ideas 710 on the left side of the page offers suggestions of resources relevant to the selected destinations and categories for potential selection for the trip itinerary.

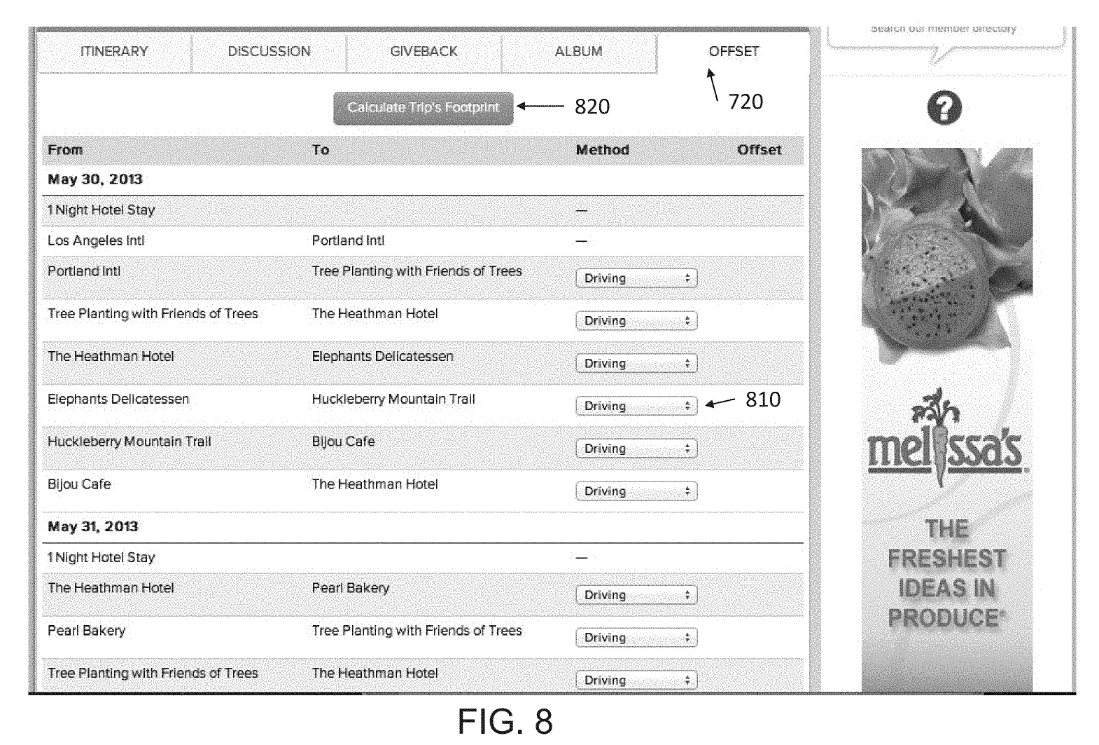

Once the trip itinerary is planned, the user may select the Offset tab 720. Example contents of the Offset tab 720 is shown in FIG. 8, according to an embodiment of the invention. For each transportation-related event, the user may select a transportation type such as driving, taking the train, walking, etc. The type of an explicit transportation event, such as flying from LA to Portland, is already known to the system. In the example, once Greg arrives in Portland, he drives from one activity to the next. For example, Greg drives from the Elephants Delicatessen to the start of the bike trail (see itinerary event 810). When the user selects the Calculate Trip's Footprint button 820, the trip planner automatically calculates distances between the starting location and ending location of each itinerary event, and based on the distance and the transportation type, determines the carbon footprint for the transportation portion of each itinerary event. The trip planner also looks up the carbon impact of other kinds of activities such as lodging and food. Certain giveback activities may be associated with a negative carbon footprint that may offset the carbon footprint of the trip before calculating a monetary offset amount. However, this may be supported only by activities sponsored by organizations that can quantify the amount of giveback associated with your completed activity and its effect on improving the environment. For example, planting a tree or participating in a coastal or river cleanup may provide a credit that may reduce the environmental impact of an overall trip.

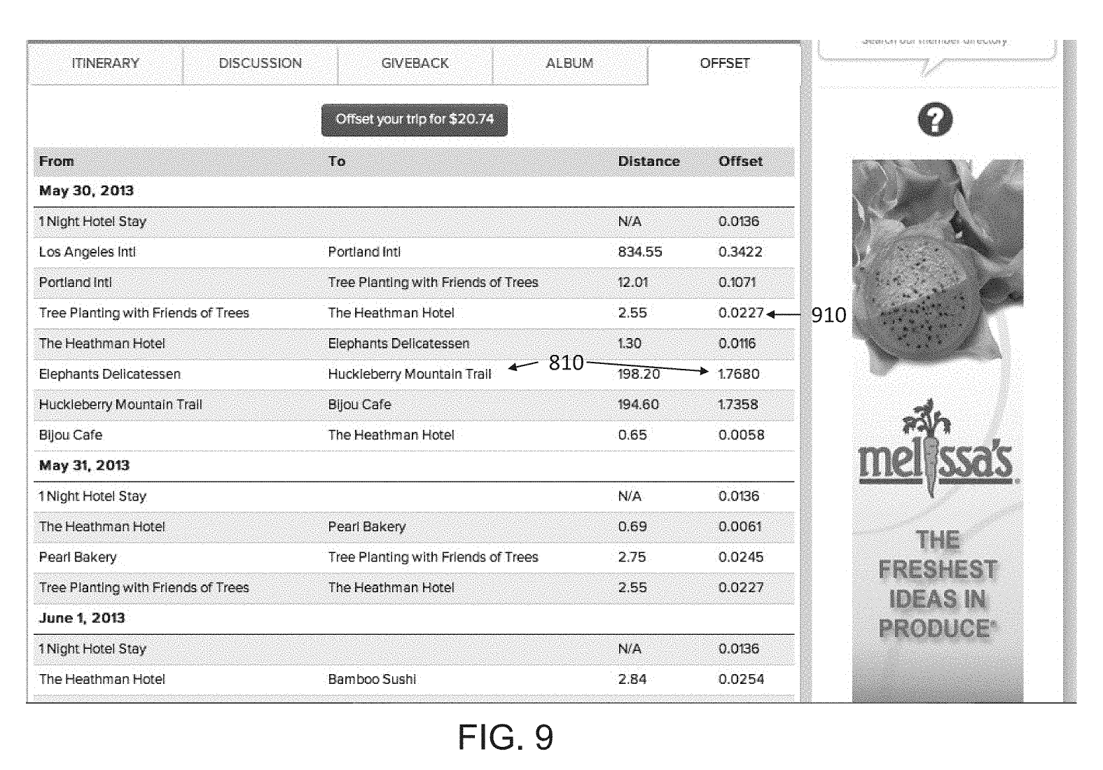

FIG. 9 shows example contents of the offset tab after calculating the carbon offsets, according to an embodiment of the invention. For example, for itinerary event 810, the drive from the Elephants Delicatessen to the Huckleberry Mountain Trail is 198.2 miles, having a carbon footprint of 1.7680. The flight from LAX to Portland is a distance of 834.55 miles requiring an offset of 0.3422. A one-night hotel stay at the Heathman Hotel on May 30 (see 910) is determined to require an offset for 0.0227 units of carbon footprint that includes the transportation to travel from Tree Planting with Friends of Trees as well as the carbon footprint of the night's lodging at the hotel (0.0136 which is seen in the first line item for each day). In an embodiment, one unit of carbon footprint may represent one ton of carbon dioxide released into the atmosphere.

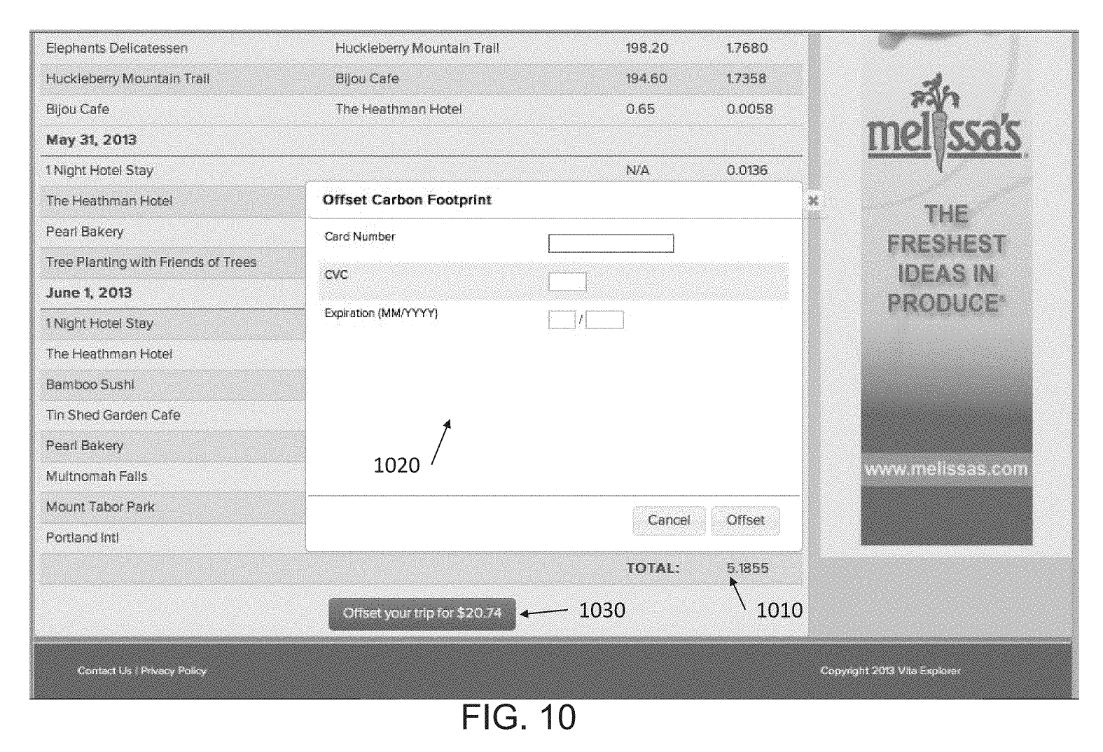

FIG. 10 is an example screenshot showing the totals for the units of carbon offsets required to offset all activities of the entire trip, according to an embodiment of the invention. In this example, a total of 5.1855 units is needed to offset the example itinerary (see 1010). A configured price per unit of carbon offset configured into the tool is used to determine the amount of money needed to offset the carbon footprint. In the example, the tool determines that $20.74 is needed (see 1030). When the user selects the Offset your trip for $20.74 button, a form may be provided for supplying credit card information for paying the $20.74, according to an embodiment of the invention (see 1020). When the user types in a credit card number which is authorized, the trip offset amount may be deposited into the user's trip planner account which may be funneled to one or more selected not-for-profit organizations that work to reduce greenhouse gases in the atmosphere, for example, Nature Conservancy or another not-for-profit that plants trees.

As mentioned earlier, the offset need not be paid at the planning stage. The user may update the itinerary to reflect changes in the actual trip that may deviate from the original plan. The user may wait until the trip concludes, update the trip itinerary, and then pay to offset the actual carbon footprint of the trip rather than the planned footprint. The user may use the trip planner multiple times throughout a period of time (e.g. for a year) and not offset any trips. The trip planner keeps track of each trips footprint and shows the total environmental impact for all trips and what has/has not been offset. The user can decide to offset all his/her trips footprints at one time in one transaction such as at the end of the year.

Placeholders in the planned itinerary may be allocated for an anticipated meal even if the particular restaurant is not known in advance. Actual specific information about a meal may or may not be added to the itinerary during or after the trip.

In an embodiment of the invention, upon returning from the trip, the traveler may be prompted to pay for the total estimated carbon impact of the trip based on the most specific information supplied in the itinerary.

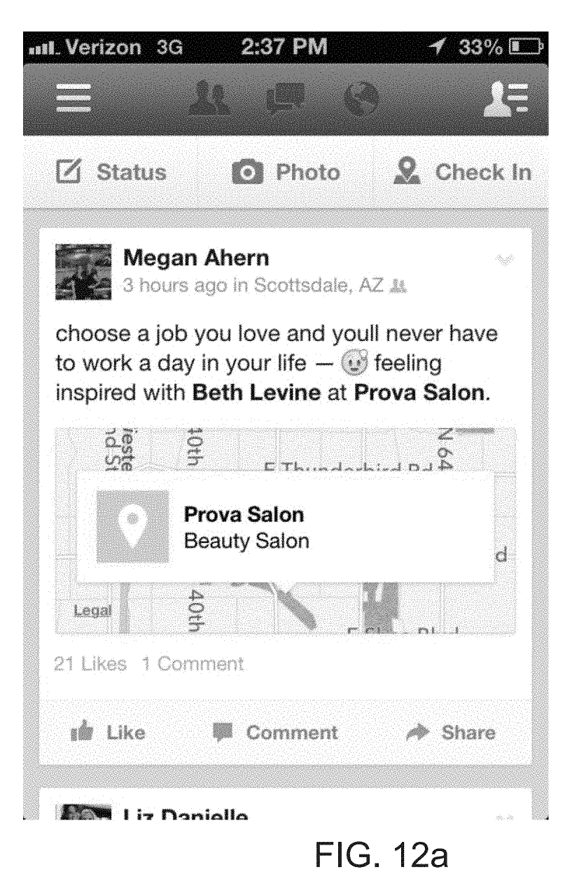

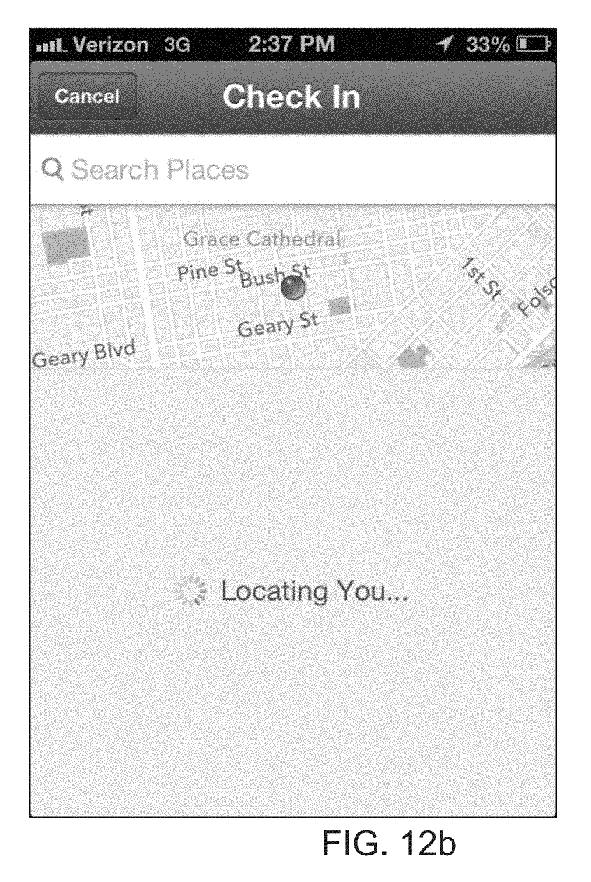

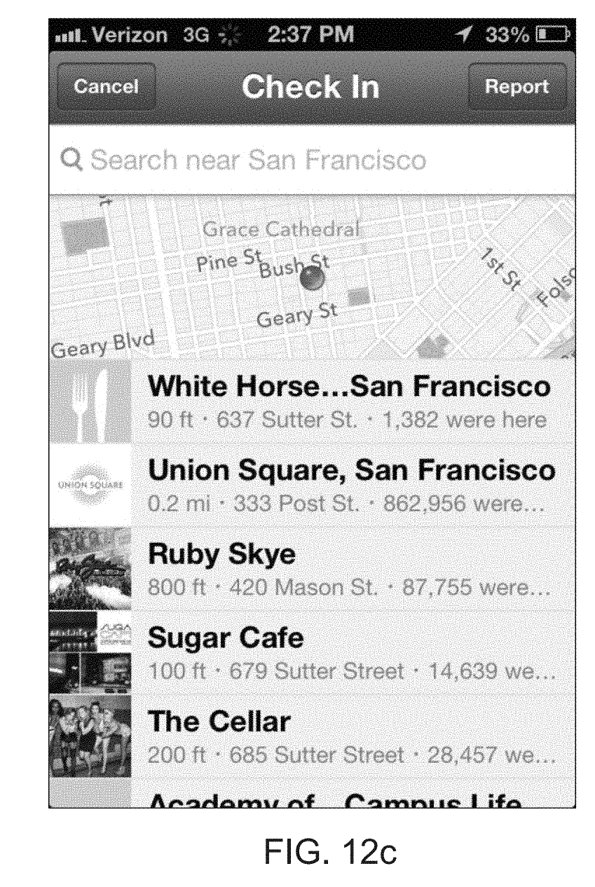

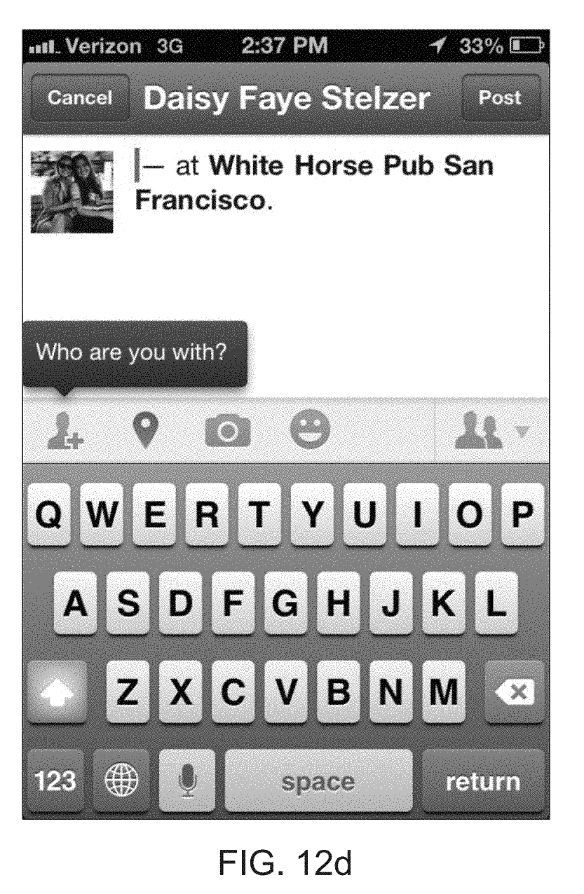

Updating a planned itinerary with actual completed trip information may be done in several different ways. In an embodiment, the traveler may use an application on their mobile device, such as Facebook on a mobile phone, to indicate where they are, when they are there, and any comments. Trip planner system integration with the mobile application such as Facebook may retrieve this check in information and compare it to the trip itinerary. FIG. 12a is a screen shot of an example mobile application that allows check in, according to an embodiment of the invention. The profile page of traveler is shown on the display of the traveler's mobile device, on which it can be seen that the traveler's friend, Megan Ahern, has checked in at the Prova Salon. The traveler may check into her current location by selecting the “Check In” link in the top right corner of the screen. Upon selecting “Check In,” the display changes to what is seen in FIG. 12b. FIG. 12b is a screen shot of a mobile device updating the screen with a map of the vicinity of the traveler, and an indication of where on that map the traveler is currently located, according to an embodiment of the invention. When the map is completely displayed, the application also provides a list of businesses of potential interest to the traveler that are close to the traveler's location such as seen in the example screen shot of FIG. 12c, according to an embodiment of the invention. For example, the White Horse Restaurant and the Skye Café are nearby. The traveler is also near a point of interest, Union Square. If the traveler selects the White Horse Restaurant entry, the mobile application can pre-populate a posting including the location and name of the restaurant, and allow the traveler to add notes. When finished, the information may be posted on a social media bulletin board, and the trip planner system may receive check in information for the White Horse Restaurant. If a meal at the White Horse Restaurant is in the itinerary, the trip planning system may update the trip progress with an indication that this portion of the trip has been completed. If the White Horse Restaurant is not on the itinerary, the trip planning system can create a new itinerary entry for the White Horse, determine and record the destination of the White Horse Restaurant from the previous check in location, and update the next segment of the trip with the estimated distance between the White Horse Restaurant and the next expected check in point. In an embodiment of the invention, if the next expected destination is a restaurant, the trip planning system may prompt the user to choose whether the White Horse Restaurant should replace the previous restaurant itinerary entry or simply be added to the itinerary.

An embodiment in which a traveler checks into locations of interest may be useful for offsetting a trip for which there is no pre-planned itinerary. The act of checking in provides the trip planning system with the location and type/category of itinerary items from which to construct a very basic retrospective itinerary.

In another embodiment, the trip planner may be used in conjunction with a mobile application that proactively provides traveler information periodically without the traveler having to check in. This embodiment minimizes the amount of traveler interaction required to determine the carbon offset of the trip. With the trip geo-location configuration option 640 turned on and the traveler's mobile device enabled to broadcast or respond to a request for information regarding the device's location, the trip planning system may receive steady stream of traveler location data over time. The trip planner can use this information to identify the travel route and stopping points. If a pre-planned itinerary exists, then when the location of the traveler comes within a threshold distance of the location of an itinerary event, the traveler may be automatically checked in, or prompted to confirm check in. For example, if the traveler Daisy had been planning to visit Union Square, the trip planner may automatically determine that the trip to Union Square has completed, or the system may prompt Daisy to confirm that she has, in fact, arrived at Union Square.

In another embodiment in which there is a pre-planned itinerary that will be followed closely, a mobile device need not be enabled for providing location information. This embodiment is advantageous for those who do not want their location to be continually tracked. Instead, the trip planner may send a prompt to the traveler's mobile device, with which the traveler interacts with (clicks, touches, responds to, etc.) to check into the next itinerary event. For example, referring to Greg Bellow's itinerary in FIG. 7, once Greg checks in to his flight at the airport, the trip planning system may send a prompt, which when responded to, may check Greg in at “Tree Planting with Friends of Trees.” Once checked into the tree planning activity, the trip planning system may generate a new prompt for checking into the Heathman Hotel. Such an embodiment may be, but is not required to be, integrated with another third party application.

Regardless of how check in occurs, the traveler may be prompted to provide the trip planning system with supplemental information that the system cannot infer automatically. For example, using geo-location, the system may not be able to tell which of several businesses in the area are the intended check in location. However, with technological advances in which mobile devices are becoming more contextually aware, the mobile device may sense that the traveler is in a restaurant, a park, a theater, etc. and this contextual information may be used to help disambiguate among business and used to select a check-in destination among co-located business.

The view of the trip planning itinerary may change as a result of checking in. For example, continuing to refer to FIG. 7, the icon representing a particular itinerary entry may be displayed as faded (e.g. grayed out) once the trip is underway, but displayed sharp and bold upon checking into that event. Alternatively, any visual indicator may be provided in each itinerary entry, such as a light that illuminates or a box that is checked, when the traveler checks into an event. In addition, if geo-location is enabled, the actual distance travelled may be updated in the Offsets screen. Although not explicitly shown in FIG. 9, the distance column may be updated with the actual distance travelled, and a visual indicator, such as the use of color, may identify the distance reported as representing either estimated or actual distances. Alternatively, a separate column may be provided with the actual distance travelled.

Upon returning home, the actual itinerary may be completely or only partially filled out. The traveler may use the trip planning tool to supply any additional detailed information for making the estimated carbon impact of the trip more accurate.

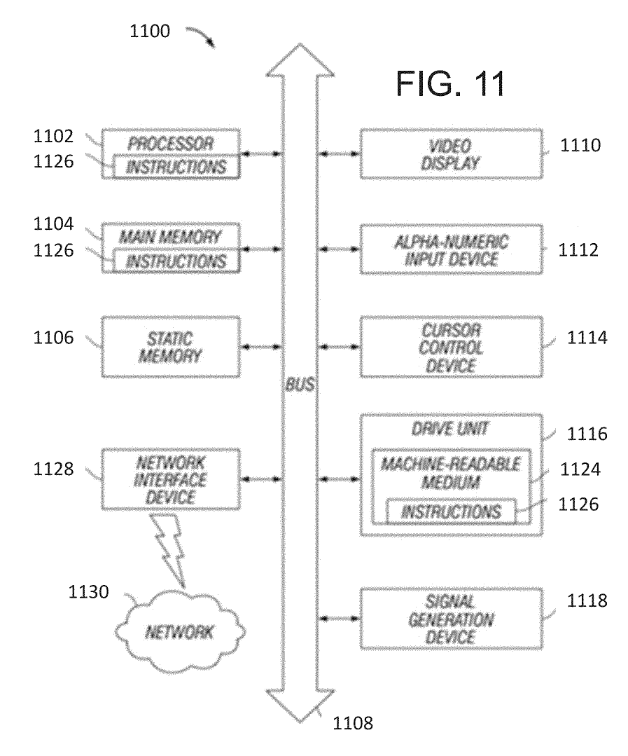

FIG. 11 is a block schematic diagram of a machine in the exemplary form of a computer system 1100 within which a set of instructions may be programmed to cause the machine to execute the logic steps of the invention. In alternative embodiments, the machine may comprise a network router, a network switch, a network bridge, personal digital assistant (PDA), a cellular telephone, a Web appliance or any machine capable of executing a sequence of instructions that specify actions to be taken by that machine.

The computer system 1100 includes a processor 1102, a main memory 1104 and a static memory 1106, which communicate with each other via a bus 1108. The computer system 1100 may further include a display unit 1110, for example, a liquid crystal display (LCD) or a cathode ray tube (CRT). The computer system 1100 also includes an alphanumeric input device 1112, for example, a keyboard; a cursor control device 1114, for example, a mouse; a disk drive unit 1116, a signal generation device 1118, for example, a speaker, and a network interface device 1128.

The disk drive unit 1116 includes a machine-readable medium 1124 on which is stored a set of executable instructions, i.e. software, 1126 embodying any one, or all, of the methodologies described herein below. The software 1126 is also shown to reside, completely or at least partially, within the main memory 1104 and/or within the processor 1102. The software 1126 may further be transmitted or received over a network 1130 by means of a network interface device 1128.

In contrast to the system 1100 discussed above, a different embodiment uses logic circuitry instead of computer-executed instructions to implement processing entities. Depending upon the particular requirements of the application in the areas of speed, expense, tooling costs, and the like, this logic may be implemented by constructing an application-specific integrated circuit (ASIC) having thousands of tiny integrated transistors. Such an ASIC may be implemented with CMOS (complementary metal oxide semiconductor), TTL (transistor-transistor logic), VLSI (very large systems integration), or another suitable construction. Other alternatives include a digital signal processing chip (DSP), discrete circuitry (such as resistors, capacitors, diodes, inductors, and transistors), field programmable gate array (FPGA), programmable logic array (PLA), programmable logic device (PLD), and the like.

It is to be understood that embodiments may be used as or to support software programs or software modules executed upon some form of processing core (such as the CPU of a computer) or otherwise implemented or realized upon or within a machine or computer readable medium. A machine-readable medium includes any mechanism for storing or transmitting information in a form readable by a machine, e.g. a computer. For example, a machine readable medium includes read-only memory (ROM); random access memory (RAM); magnetic disk storage media; optical storage media; flash memory devices; electrical, optical, acoustical or other form of propagated signals, for example, carrier waves, infrared signals, digital signals, etc.; or any other type of media suitable for storing or transmitting information.

In some embodiments the user and/or member profile can be generated by collecting information about the user from a plurality of devices/sensors associated with the user. The devices and sensors can include lighting devices in the user's home, user's mobile device such as a cellular phone, wearable devices, and devices coupled to an automobile which can provide information such as diagnostic information. Devices can also include home devices such as refrigerators, thermostats, the sprinkler system, the user's computers, assistant devices, stoves, ovens, dishwashers, washing machines and dryers, pool heaters, and other devices which can generate information which can assist in calculating a carbon footprint associated with the user and/or the user's environment. In some embodiments the device information can be collected from sensors communicatively coupled to the devices. In at least one embodiment, the devices can include sensors which can provide information (in some embodiments via sensor signals) about the device. The user's environment can include a user's workplace, user's primary home, other dwellings associated with the user, and/or other environments which can be associated with the user. In some embodiments, the devices associated with the user can include a global positioning system which can provide information/sensor signals about the location of the device and/or the user. In at least one embodiment the devices can be connected via a central hub and the information about devices can be collected via sensor signals.

In some embodiments, the devices and/or sensors can collect, via sensor signals, information such as characteristics associated with the user such as devices usage information or location. These characteristics can include the status of the device/sensor signals, the geographical user associated with the device, automobile starter such as the average speed of an automobile during a time period, the speed of the automobile, automobile battery use, throttle status, distance driven, the vehicle location, and/or driving habits.

In some embodiments, characteristics can include information about the user can be collected such as demographic information, house location, schedule and/or itinerary, age, dietary habits, number of houses associated with the user, number of people living in the houses, automobile information such as type of vehicle and the number of users using said vehicle, and other information relevant to calculating the carbon impact associated with a user and/or group of users. In some embodiments the one or more device can be connected to a central hub.

A user profile can be built using one or more of the characteristics. In some embodiments, further information can be derived about a user by identifying a cluster associated with the user. The clusters can be generated by analyzing the similarity between user profiles. The clusters can be generated using one or more of clustering algorithms and/or machine learning algorithms the clusters can be dynamically updated as more information becomes available about users. In at least one embodiment, the user can be monitored for a period (i.e. a day, a month, a year). The information collected from the user monitoring can be analyzed and characteristics about a user can be derived. For example a user's average carbon impact can be determined. In at least one embodiment the granular information about a user can be determined such as average carbon impact per day of the week (e.g., Monday), average carbon impact per a specific month (e.g., September), and/or average impact per activity (e.g., commute to work). In at least one embodiment the collected information can be analyzed to determine a predicted user's itinerary. In at least one embodiment the user's average carbon impact can be used as a benchmark to determine goal carbon impact threshold.

In some embodiments, a carbon footprint goal can be received. In some embodiments, the carbon footprint goal is a generated by analyzing the other carbon footprint of user profiles in a cluster and determining a carbon footprint goal which is the average carbon footprint of the cluster. In some embodiments, a determination can be made of a carbon footprint goal using machine learning algorithms to determine a carbon footprint goal which is attainable for a user based on the characteristics of the user profile. In some embodiments, the carbon footprint goal is determined by factoring in the carbon footprint usage of the cluster and the characteristics of the user profile to determine a goal for the user.

In at least some embodiments, a threshold time period can be selected. For example, a threshold time period can include an event (e.g., conference), an activity (e.g., commute to work), and/or a temporal period (i.e., two hours, one day, a week, a year, etc.). In at least one embodiment, the goal is associated with the time period and can represent the maximum carbon footprint impact the user and/or users is willing to tolerate in the time period.

In at least one embodiment, a historical usage pattern can be determined using the carbon footprint impact data which represents the users prior carbon footprint impact. The historical usage patterns can identify usage patterns such as patterns related to a day (i.e., weekday, Monday, weekend, Sunday, Saturday, etc.), a season (i.e., spring, winter, etc.), activity (e.g., vacation, commute to work, etc.). In at least some embodiments, the data from the user profiles in the associated cluster of the user profile can be used to determine a historical usage pattern. The historical usage pattern can be identified using one or more machine learning algorithms.

In at least one embodiment, the user schedule can be determined based on information received from devices (e.g., past trips, past activities, current activity, etc.). In at least one embodiment, information received from devices is analyzed to determine a predicted schedule or itinerary for the user. In some embodiments, the predicted schedule is determined by analyzing the user's calendar and/or other data sources such as the user's email.

In an embodiment where user sets a goal carbon footprint for a threshold time period (e.g., 100 lbs. per day), the user's schedule (can include predicted schedule) can be analyzed to determine the items of the schedule already completed. Furthermore the historical usage data can be used to predict the carbon impact of the items on the user schedule (e.g., itinerary) which have not been completed. The carbon impact associated with the user schedule's for the threshold time period can be analyzed. In some embodiments, a determination can be made that the carbon impact associated with the user schedule exceeds the carbon footprint goal amount for the threshold time (e.g., predicted 200 lbs. for the day instead of 100 lbs). In some embodiments, the predicted schedule can be analyzed and recommendations can be made to the user suggesting a change to the predicted schedule which would lower the carbon footprint impact for that predicted or anticipated schedule/itinerary. For example, it can be suggested to the user to leave work 30 minutes later than usual to avoid traffic which can result in a lower carbon footprint. The recommendation to modify user behavior can be based on user's historical usage patterns and/or external sources such as a website predicting automobile traffic.

In at least one embodiment information collected (in some embodiments via sensor signals) from the user devices and/or sensors (can include historical use patterns) are modeled (e.g., data modeling) to determine the relationship between user activities (i.e., eating at a specific restaurant, driving to work, etc.) and the carbon footprint. In at least one embodiment a user profile is clustered with other user profiles and the data model is built using the information collected from the cluster. For example, user profiles clusters can be generated based on factors such as geographic location. The data collected from the user profiles in the cluster can be used to generate a data model which is relevant to the users in the geographic location. In some embodiments the data models are built based on the user profile without the use of other user profiles. In other embodiments the data models are built using data from all users of the system. In at least one example, the carbon footprint impact can be determined per square footage of a house in the cluster associated with the user, this information can be used to determine the carbon footprint impact associated with the user.

In response to the recommendation, a user can modify his or her behavior. For example, the user can select to leave work 30 minutes later per the suggestion. The predicted schedule can be modified based on the user behavior and the carbon impact associated with the user schedule can be updated. In some embodiments, multiple recommendations can be made to the user to modify his or her behavior.

In at least one embodiment, the user can be presented with an option to pay down the carbon footprint impact. In some embodiments the user can be presented with the option to pay down the carbon footprint impact which exceeded the carbon footprint goal. In at least one embodiment, the user can be presented with an option to offset the carbon footprint impact including the carbon footprint goal. Users can also be presented with an option to offset the carbon footprint impact of other users for example other conference attendees and/or members of the household.

Options to pay down the carbon footprint impact can include performing an action (i.e., watch an advertisement, plant a tree, river clean up, etc.), and/or a recommendation to pay money to an organization which can offset the carbon impact of the user. In at least one embodiment, the user can pay down the carbon footprint impact using credits accrued through actions like shopping on specific websites, or watching advertisements. The recommendation indicating an organization to offset the carbon impact of the user can be determined based on user's previous selections (e.g., user chose an organization in the past), user information (e.g., organization in the user's location), and/or the user cluster (e.g., organizations commonly chosen by users associated the cluster).

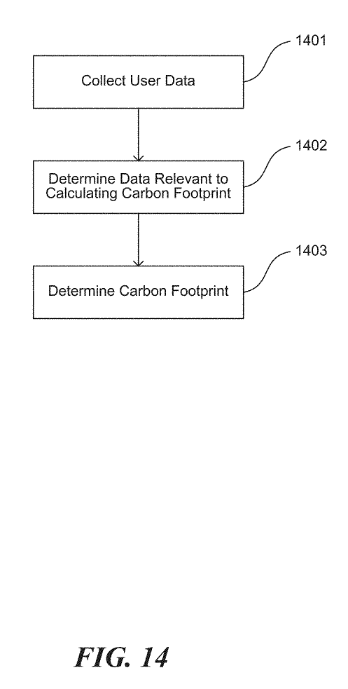

FIG. 14 illustrates an embodiment of a carbon footprint determination. In some embodiments, user information can be collected about a user 1401. Users and/or members can be individual users and/or groups. The user information can be collected from the member, information associated with the member (i.e., credit card statements, emails, etc.), and/or derived. User information can include information which is relevant to a calculation of the carbon offset. This information can include user's address, user's work address, information about the user's home, automobile, diet, exercise habits, shopping habits, commuting habits, age, gender, weight, height, and/or travel information. Information can also include the number in the household, the amount of money spent on electricity, miles driven annually, types and/or models of vehicles, modes of public transportation take it, calories consumed, preferred food (e.g., chips) and/or drink (e.g., soda), amount of money spent on clothing and/or other goods or services. The information can also include login information to different websites, databases and/or software. The login can include login information for data sources such as travel sites, banks websites, carpool applications, rideshare service application, corporate retreat applications, utility websites, email, social media, tax software, financial services, shopping websites, Internet of Things (loT) devices and/or credit card websites.

In at least one embodiment a user's credit card and/or bank statements can be used to identify carbon footprint. For example, this statement can be analyzed and the information collected could be determined when a user places orders online. The line item on the statement can be identified as an online order by data associated with the purchase such as a category of the transaction listed as online shopping and/or the order can be identified as an online order by the name of the merchant, for example, Amazon™. The line item on the statement can also be checked against the user's email to determine that the order was an online order. In at least one embodiment, the user's credit card and/or bank statements can be used to parse out the spending information (i.e., amounts spent, merchants, etc.). In at least one embodiment, the user can be presented with a list of purchases (e.g., transactions) and/or category the list by types of transactions (e.g., food, shopping, etc.).

In at least one embodiment the credit card and/or bank statement can be used to identify a purchase is a travel related purchase. The purchase can be identified as a travel related purchase by analyzing the category of the transaction (i.e., travel category) and/or by the name of the merchant, for example, Hotwire.com™. In some embodiments, the user's social media and/or email account can be used to determine information about the travel related purchase. For example, if a purchase from hotwire.com is identified a user's social media can be scanned to determine that the user is going on a cruise to Mexico and that Hotwire purchase can be classified as a cruise. In an example of a purchase from hotwire.com is identified the user's emails can be scanned for emails of the hotwire.com itinerary and based on that itinerary additional information can be gathered about that purchase (i.e., flight, cruise, rental car, etc.).

Travel information can also be gathered (in some embodiments via a sensor signal) using the Global Positioning System (GPS) associated with the user, for example, the GPS can be used to track users movements. Those movements can further be analyzed to determine when the user is walking, biking, driving, flying, etc. The speed of the movements can be used to determine this information. For example, if the GPS determines that the user is moving 50 miles an hour over land, it can determine that the user is driving. If the GPS determines that the user is moving 50 miles an hour over water, it can be determined that the user is in a boat.

In some embodiments, the accelerometer sensor built into the device associated with the user (i.e., phone, fitness tracking device, etc.) and it can keep track of the user's movements. The information gathered by the accelerometer sensor can be further used to determine activities, for example, when it is determined that the user is moving 15 miles an hour over land the accelerometer sensor can assist in distinguishing, for example, between the user running, the user biking and/or roller-skating. In some embodiments, the user's vehicle may collect travel information this information can be used to determine the carbon footprint of the trips associated with the car. In at least one embodiment, an interface can be created to automatically import the trip information from the automobile to the application. In at least one embodiment, this interface can be created to other sources which can provide information about a trip, for example, a carbon footprint interface located on ships, planes, hotels, and restaurant. The carbon footprint interface can be associated with a venue (i.e., hotel, restaurant) and/or transportation (i.e., plane, cruise, car). The interface can be set to provide patrons with information about the carbon footprint (e.g., electricity used) on average by patrons or it can be tailored to the specific patron. For example, a user who stays in a hotel room can use the carbon footprint interface to determine her actual carbon footprint by connecting to the hotel's carbon footprint interface.

In at least one embodiment, additional information which can be used to calculate the carbon footprint can be collected 1402. For example, external information can be accessed (i.e., websites, public records, etc,). In at least one embodiment where user identifies his or her home, the home square footage can be determined by determining the average square footage of houses in the user's neighborhood, by interfacing to a database having square footage information of the specific house (i.e., Zillow™, County Clerk's office, etc.), or the square footage can be determined by measuring the user's GPS/travel at that address. For example, if Tom lives at 1 Main Street Smalltown, Calif. 94000 and the square footage information is not entered by the user, then an online database can be accessed to determine whether the square footage is available.

In the example, Zillow.com™ can be searched and once the address “1 Main Street Small Town, Calif. 94000” is identified, the website can be parsed to identify the square footage information and imported. In some embodiments, other relevant information such as the cooling system type, heating system type, number of bedrooms, number of bathrooms, swimming tool type, and the size of the lot can also be determined. This determination can be made by parsing a website and/or accessing a database. In some embodiments, this determination can be based on available information nearby homes. For example, if the information is not available for Tom's house, information can be gathered about the homes in Tom's neighborhood and the most common and/or average characteristics (i.e., information) of those homes can be associated with Tom's. For example, if the average square footage of a home in Tom's neighborhood is 1,500 sqft. then it can be determined that Tom's home is 1,500 sqft. In another example, if most homes in Tom's neighborhood are 1,200 sqft. then the mode can be determined to be 1,200 sqft. and this square footage can be assigned to Tom's home. In at least one embodiment information can be analyzed about a user's carbon impact and this information can be used to predict the behavior of other users in the cluster.

In at least one embodiment, the credit card and/or bank statement can be analyzed to determine information about the user's diet. For example, grocery store names can cause the determination that the purchase was for groceries. This information can be cross-referenced with information already known about a user. For example if the users had entered and said that the user is vegetarian then a determination can be made about the carbon impact of vegetarian groceries. Other information can be used to determine the carbon impact of groceries such as the user's age, gender, and weight. Names of restaurants can be used to identify carbon impact of activities related to dining at restaurants additional information can be used by the user to determine the carbon impact, for example, the user's diet, the user's weight, and/or other information about a user can be used to determine the carbon impact of eating at a restaurant. In at least one embodiment, information about what the user is likely to eat can be determined based on social media posts. For example, if a user posts pictures of only vegetarian dishes then it can be determined that the user is likely vegetarian. In at least one embodiment a critical number of posts can be required to make this determination (e.g. 20 posts). User's posts can also be analyzed. For example, if the user posts “today I became vegetarian,” then this post can be used to determine that the user is vegetarian. In at least one embodiment, the post is parsed to determine whether information in the post is irrelevant this can be done by a visual recognition algorithm, character recognition algorithm, and machine learning techniques to determine whether the post contains relevant carbon footprint information (i.e., diet, travel, lifestyle, etc.).

In at least one embodiment, user's photographs can be analyzed to determine information about the user such as travel information, diet information, and information about the home. In at least one embodiment, the user's photographs can be accessed from the user's social media accounts. In other embodiments, the photographs can be accessed from the user's devices. For example, the user's pictures folder on the mobile device can be used identify photographs as they are taken. Photographs can be analyzed to determine the subject of the photograph. For example, food types can be identified, locations can be identified and/or other information such as mode of transportation (i.e., cruise ship, plane, etc.). In an example where the user uploads a picture of Lake Tahoe, it can be determined that the user is currently at Lake Tahoe. The text associated with the upload of a picture can also be identified for example if the user posts “I was in Tahoe two weeks ago” it can be determined that the user was in Tahoe two weeks ago and is not at Lake Tahoe currently. Additionally, metadata associated with photographs can be used to identify information about the picture and when it was taken. For example, date and/or geolocation according to associated with photographs can be used to determine when the picture was taken or the location where it was taken. Using the information collected, a carbon footprint can be calculated 1403. In some embodiments, the carbon footprint is calculated for individual activities such as a commute, a dinner date, or a plane ride. In other embodiments, the carbon footprint can be calculated for an activity which is comprised of an itinerary. An example of an itinerary can include a work retreat which can be comprised of dining, travel, and hotel stay. Other examples of an itinerary can be vacation which can include travel to a cruise ship, travel on the cruise ship, stay in a cabin, and dining. In some embodiments, the carbon footprint can be calculated for a group. For example, in a corporate setting, the carbon footprint can be calculated for the entire company. In other examples, the carbon footprint can be calculated for members of an immediate family. In at least one embodiment, the carbon footprint can be calculated for a group then displayed to individual members of the group based on a calculation of their portion of the carbon footprint. In another embodiment, the carbon footprint can be calculated for individual members of the team and then add it to generate a carbon footprint for the group.

In at least one embodiment, the users activity can be monitored and suggested techniques to lower the carbon footprint can be provided. For example, when a user adds an item to a shopping cart (including online shopping carts) a suggestion can be provided to the user to purchase an item having a lower carbon footprint impact instead. Factors used to recommend an alternate item can include information such as the materials of the item, manufacturer, seller, item performance (e.g., energy saving appliances), the location the item was manufactured, and/or the shipping distance. In at least one embodiment, the user activity of shopping can be added to the predicted schedule and/or dynamically updated based on the user's behavior. In at least one embodiment, the factors can be stored in a database. For example, when a user adds a lightbulb to a shopping cart a suggestion can be presented to the user to purchase an energy-saving lightbulb. In at least one embodiment, the user can be provided with warning messages when the user activity has high carbon impact and no recommendations can be provided to lower it. In at least one embodiment the user can be provided with information about the user's predicted itinerary and/or the items performed. The information can be provided in separate tabs and/or split screen format. In at least one embodiment the information can include the carbon impact of the item and/or the predicted carbon impact of the item.

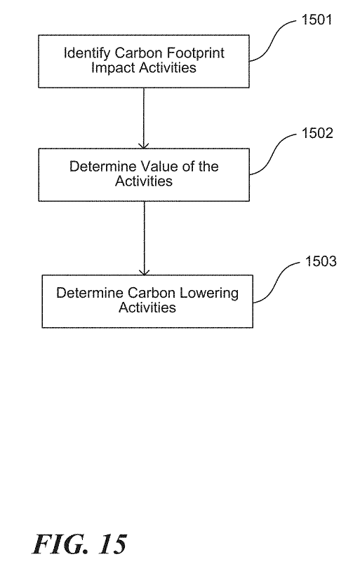

FIG. 15 illustrates an embodiment of suggesting carbon lowering activities. Carbon footprint activities can be identified 1501. In some embodiments, carbon footprint activities to be calculated can be identified by the user. In at least one embodiment. carbon footprint activities can include activities related to home, automobile, diet, shopping habits and/or travel. The carbon footprint of activities can be tracked as value assigned 1502. For example, a member's commute can be tracked using the methods described (e.g., via interface to navigation software) and determine to be a certain carbon footprint value (e.g., carbon emissions of 65 lbs.). Each activity can have an associated list of tasks which a user can perform to lower set activity. In at least one embodiment, each activity is stored in a database in association with an associated list of tasks or recommendations that can lower the carbon footprint of set activity. Furthermore, each time a task is suggested to the user the suggestion can be tracked thereby allowing the application to keep track of the number of times that user is asked to perform a task. Each task can be associated with a schedule. This feature can be used to prevent the user from getting annoyed. For example, tasks with activities involving an automobile can include keeping tires inflated, the speed limit, performing maintenance on the automobile and replacing the oil and fuel filters according to a schedule. In the example, the task of performing maintenance on the automobile can be associated with the schedule as indicated by the manufacturer (i.e., 6 months, 2 years, etc.). The schedule can be an average schedule based on available information (e.g., standard schedule for an oil change can be 6 months). This feature is especially useful when the user's vehicle is not known. In some embodiments where the user's vehicle is known that information about the schedule can be obtained from the manufacturer and/or another source. Tasks associated with activities involving a home can include installing a programmable thermostat, updating light taking devices, installing water conserving showerheads, installing water conserving toilets, and/or updating the insulation. Tasks associated with an office can include occupancy sensors for light bulbs, setting printers to print double-sided, and/or enabling power management.

In some embodiments, the schedule associated with the task can be determined based on user behavior. For example, if based on the user behavior once presented with the task suggestion, the user is determined to become frustrated and then the schedule associated with the task (e.g., reminder to print double-sided) can be dynamically updated to a longer period of time (i.e., every 5 weeks, every year, etc.). The user's behavior can be measured by analyzing how are user interacts with the application for example when a user immediately closes the suggested task a can be determined that the user is annoyed by the suggested. A threshold amount of time can be used to measure the immediacy (i.e., 2 seconds, 50 milliseconds, etc.). In some embodiments, the user's behavior immediately after closing the suggested task can be used to determine the user's frustration level. For example, if the user, after closing the task suggestion, immediately clicks on the help section of the application a can be determined that the user is frustrated and is looking for a way to prevent the tasks from becoming displayed. The recommended task can be provided via email, text, a display on an application, and/or another form of communication.

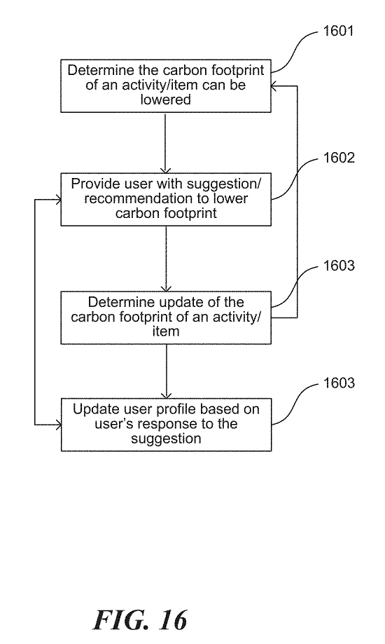

FIG. 16 demonstrates an embodiment of a process to recommend tasks to lessen the carbon footprint. The carbon footprint of an activity can be determined then analyzed to identify how it can be lowered 1601. The carbon footprint of activities can be lowered by performing the tasks described in FIG. 15 and also by changing behavior. Changing behavior can include simple adjustments which a user could make that would result in a lower carbon footprint. For example, it can be determined that if the user takes a more efficient route to work the carbon footprint would be lowered. In other examples, where the user is identified to be in a restaurant, the suggested change behavior can include a suggestion to order a vegetarian meal.

In embodiments where an activity is a set of activities such as a conference, a user can be provided with a suggested behavior for each item on an itinerary which results with a low carbon footprint. The itinerary can include a predicted schedule. The predicted schedule can be based on historical usage patterns and/or past user behavior (e.g., driving home). For example, an activity can be set to a user's work day which can include itinerary items of commute to work, working in offices, picking up lunch, working office, and commuting home. That itinerary item of the commute can include a destination address. The information in itinerary can be analyzed for example a row can be mapped and the most efficient route identified. Additionally, multiple commuting times can be tested to identify the best commuting time. In some embodiments, the user can specify a range of acceptable times including leave the starting point (e.g., 6 am-8 am), and/or arrive at the destination point (e.g., 8 am-10 am). The testing can include analyzing historical traffic data to identify the most efficient time to leave a starting point. This can be done for other items on the itinerary as well. For example, it can be determined that the most carbon footprint efficient meal for lunch is vegan. In some embodiments, the user can enter their eating preferences and/or their restaurant preferences. Based on the preferences identified by the user the most carbon footprint efficient recommendation can be provided. In at least one embodiment characteristics of activities and/or items are stored allowing for the calculation of the carbon been footprint activity and/or the lower carbon footprint suggestion.

In at least one embodiment, a user can set a goal carbon footprint for a period of time (i.e., duration of an activity, hour, day, week, month, year, etc.). The suggestion for the carbon footprint recommendation can be dynamically updated and provided to the user. A user's daily itinerary can include breakfast, commute to work, working in offices, lunch, working office, commuting home, and dinner. If the user sets the goal of the carbon footprint to 100 lbs., and each item on the itinerary can be assigned a carbon footprint value based on user's historical data, user data, and/or it can be calculated based on the available information.

In some embodiments, the user preferences can be factored into the suggestion or recommendation made to the user. For example, if it is set in the user's preferences that the user is not willing to eat a vegetarian meal than a vegetarian meal suggestion will not be provided to the user. The suggestions can be dynamically updated as information from the user and/or other sources is provided. For example, if 10 lbs. of a carbon footprint was allocated to the breakfast however the user skipped breakfast than those 10 lbs. of a carbon footprint can be budgeted to another activity thereby allowing a user to eat a more carbon footprint heavy dinner. In other examples where 10 lbs. of carbon footprint is budgeted for breakfast however the user eats a breakfast which causes 30 lbs. of carbon footprint, the suggestions for the other items on the daily itinerary can be dynamically updated to reflect a smaller remaining budget of the carbon footprint which could be used without exceeding the goal. At least one embodiment a database can be references to identify the carbon footprint of each food item, and/or activity. In some embodiments, a machine learning algorithm can be used to identity the carbon footprint of each food item and/or activity. The machine learning algorithm can include identifying the geographic location of the activity and/or factoring the average carbon footprint cost of similar activities. In some embodiments, a list can be provided to the user which can include each activity on the schedule and the actual carbon impact and/or predicted carbon impact.

A user can be provided with the suggestion or recommending on lowering the carbon footprint 1602. The suggestions can include changing the commute time, ordering a specific item at a restaurant, staying at a different hotel, etc. The user's response to the suggestion can be recorded. If a user agreed to change the activity than the carbon footprint of the activity can be updated 1603. The user's response can be stored in a user profile 1603. The information stored in the user profile can be used to identify the types of suggestions which the user prefers and it can influence the suggestions which are provided to the user. If a user does not agree to change activity, then this information can be stored in the user profile and can influence the suggestions that are provided to the user.

In at least one embodiment, information is collected about a user's mobile device. The information can include the battery level of the device, reception level, and/or roaming status. The application providing the suggestions/recommendations to the user can monitor the information collected about the device such as battery level. The application can change its behavior based on the information received about the device. For example, when the battery level is determined to be low the frequency of recommendations to the user can be lowered. In some embodiments the recommendation can be determined to be a high value recommendation when it lowers the carbon impact a threshold amount (i.e., 10% of the predicted carbon impact, 10 lbs, 20% lower than a current itinerary item which the recommendation can replace, etc.). In an example, when a battery level is determined to be low however the recommendation lowers the predicted carbon impact by 20% (e.g., threshold amount) then the recommendation can be displayed. In an example, when a battery level is determined to be low however the recommendation lowers the predicted carbon impact by 5% (lower than the threshold amount) then the recommendation can be set to not display.

In at least one embodiment, the suggestion/recommendation is provided during the planning phase. For example, the planning phase can include when a user is building a trip itinerary. In some embodiments, the suggestions are provided during the execution phase, for example, while the user is driving an alternative route can be suggested. In some embodiments suggestions can be made after the itinerary and/or activity is completed, for example, after the user returns from a trip suggestions can be displayed about how the user could have altered the itinerary to have a lower carbon impact. In an example, a different cruise line and/or airline having a lower carbon footprint can be suggested. Suggestions can include rearranging the order of the itinerary, rearranging the destination order, choosing a different destination, lodging types (e.g., hotel versus bed and breakfast), lodging company, mode of transportation, the vehicle type, vehicle rental company, a diet, restaurants, activities (e.g., points of interest), exercise routines products for trips, and/or events (e.g. concert versus movie theater).

Other suggestions can include changing the route, carpooling, choosing a different time to travel, mode of transportation, vehicle type. Suggestions can also include change in energy source (e.g., solar), installation of artificial grass, water usage time, water usage amount, attic fan, change in diet, change of food companies (i.e., farmer's market versus supermarket, one brand of beverage versus another brand of beverage, etc.), restaurants, shopping habits (e.g., international shipping versus domestic, consolidate orders, etc.), and/or e-reader books.

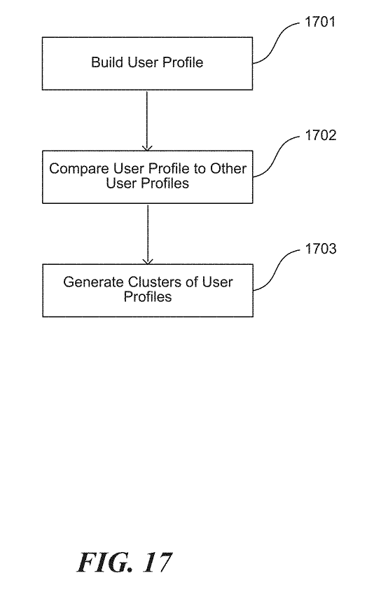

FIG. 17 demonstrates an embodiment of generating user profile clusters. Information collected about a user can be used to create a user profile. Often times users with information in common can behave in a similar way. Therefore, the information of a group of users can be used to predict information about users with the group. Information about a user's preferences, carbon footprint, incentive information, and other user information can be stored in association with a user profile. The user profile can be built using information collected about a user 1701.

To identify the group of users the user profiles can be compared to other user profiles and clusters of user profiles can be created 1703. The groupings of user profiles can be identified by cluster analysis which includes grouping a set of profiles in such a way that the profiles are similar to each other, and are more similar each other than those in other groups. The cluster analysis (clustering) can be performed using statistical data analysis, machine learning, and/or pattern recognition. Furthermore, the clustering can be performed using connectivity-based clustering algorithms, centroid -based clustering algorithms, and/or distribution-based clustering algorithms. In at least one embodiment, the clustering groups dynamically as the probability of specific factors being a more relevant factors are determined. For example, if it is determined that the age of the user is highly predictive of the user's behavior then the is so the age field of a user profile can be given higher weight than another field of the user's profile. the determination of fields which are more predictive and/or less predictive of the user's behavior can be dynamically determined as more information such as real time information about real world activities engaged in by the user and/or users. In response to the fields being determined to be less or more predictive of the user's behavior, the clusters can be updated in the user profiles and can be redistributed amongst groups or clusters.

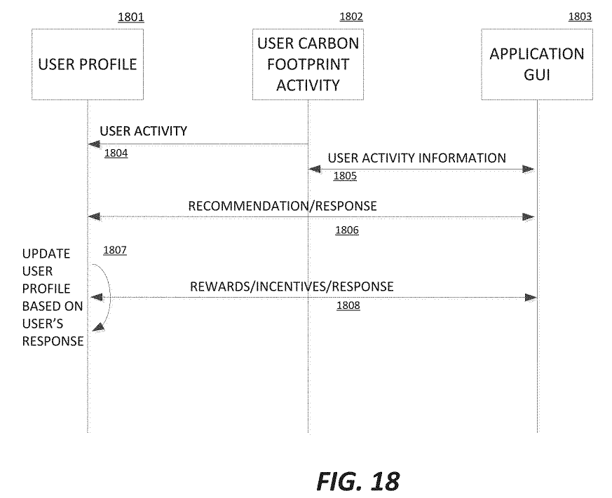

FIG. 18 illustrates an embodiment of the workflow. The user profile 1801 can store information about the user, such as user's carbon footprint activity 1802 and/or user's interaction 1805 with the application GUI 1803 including the user's response to recommendations to change behavior impacting the carbon footprint and/or users responses to rewards and/or incentives. In at least one embodiment, the user carbon footprint activity 1804 can be tracked and recorded in the user profile. In at least one embodiment, reports and/or incentives can be provided to the user for engaging in ecologically friendly activities 1808.

In at least one embodiment, incentives can be provided for ecologically friendly behavior including keeping the carbon footprint impact of low at certain threshold for a period of time (i.e. a day, a week, month, year, etc.). In some embodiments, the ecologically friendly activity can include lowering the carbon footprint by a percentage (e.g., 10 percent). For example, a user's carbon footprint impact can be monitored for a period of time (e.g., one week, three weeks, a month, etc.) then a user can be provided where the recommendations and/or suggestions to lower the carbon footprint 1806.

The user's activity can then be monitored, and if the user lowers the carbon footprint by a percentage the user can be provided with incentives 1808. Incentives can include rewards such as gift cards. In at least one embodiment the incentives can include points which can elevate a user's status (e.g. silver level, gold level, diamond level). In some embodiments, the levels can be associated with discounts of membership fees, and/or access to events (free concerts). In at least one embodiment, the levels can represent user's engagement scores similar to a game. In at least one embodiment, the incentives the rewards can be provided to the user based on the number of recommendations the user accepts. For example, a point can be assigned for accepting a suggestion. In some embodiments, the points can be assigned to per difficulty of suggestion. For example, a difficult suggestion to accept such as leaving for a work commute an hour earlier can be assigned 10 points while leaving for a work commute 10 minutes earlier can be assigned 2 points. In at least one embodiment the user's profile can be updated 1807 based on the response to the recommendations and/or suggestions, and/or response to rewards in our incentives.

In at least one embodiment, the difficulty of implementing the suggestion can be identified by analyzing the user's profile. For example, it can be determined that a user's time of arrival at work is not strict and therefore it can be determined is not difficult for the user to leave for the work commute at a different time. The score assigned to the suggestion can be based on the analysis of the user's profile 1808.

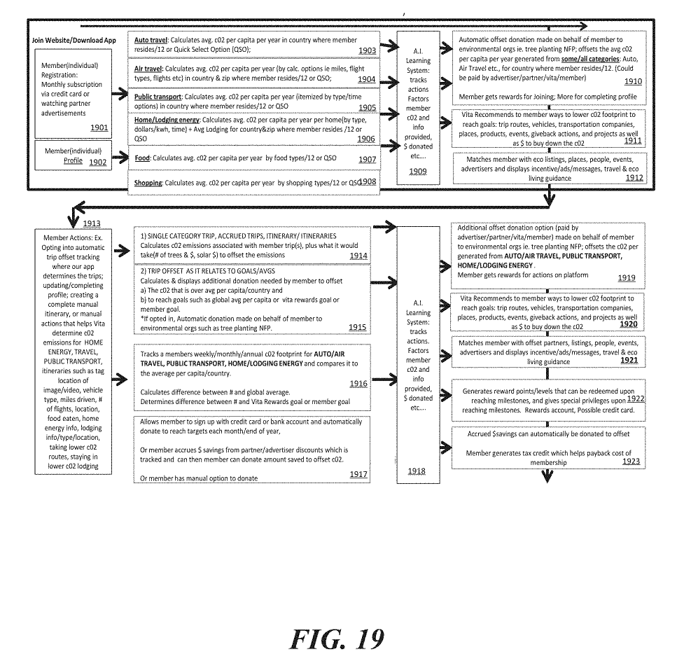

FIG. 19 illustrates an embodiment of the workflow. A member sign-up for a monthly subscription using a credit card and/or through a partner (i.e., website, employer, etc.) 1901. In at least one embodiment, once a member signs up for the monthly subscription the member and/or individual and/or user can be associated with a profile 1902. Information can be gathered about a user including auto travel information 1903, air travel information 1904, public transportation 1905, home and/or lodging energy use 1906, type of food eaten by the member 1907 and/or shopping habits of the member. This information can be evaluated using an artificial intelligence system 1909. In at least one embodiment, an automatic carbon offset donation can be made on behalf of the member to an environmental organization such as a tree planting organization 1910. In at least some embodiments, a recommendation to the user can be provided to lower the carbon footprint, the recommendation can include altering trip routes, changing transportation companies, etc. 1911.

In at least some embodiments, the user can be provided with the opportunity to engage in activities which are associated with a carbon offset 1912. In at least one embodiment, activities associated with the carbon offset can include watching advertising videos, purchasing products at stores, and/or clicking on advertisements. The companies whose material the user interacts with can pay for the user's carbon offset. For example, when a user watches an advertisement for car company X, the company car X can donate to an environmental organization to buy down the carbon offset of a user. Similarly, a merchant on whose website a user purchased a product can donate an amount to offset the carbon footprint. In at least one embodiment, a user can be provided with an interface to a website, the interface can track that the user accesses the website and can track the user's interaction with the website to accurately calculate the value which the company associated with the website will pay for the user's interaction with the website.

In at least one embodiment, the user's actions can be monitored the actions can include opting into automatic trip offset tracking where the application determines the trip, updates user profile creates an itinerary, etc. 1913. In at least one embodiment, an activity can include can include a plurality of trips, itineraries, etc. 1914. In at least one embodiment, a goal to be set by the user and the offset can be calculated 1915. In at least one embodiment, the trip offset is calculated by determining the carbon impact average per capita in the user's country and a goal can be set to exceed the average (i.e., lower impact than the country's average, lower impact than the average user, etc), to reach a rewards level, and/or to reach a goal identified by the user. In at least one embodiment, the users carbon impact and/or carbon offset can be tracked and compared to the average in the user's region 1916. In at least one embodiment, this calculation can be used to provide the user with rewards and/or incentives. In at least one embodiment, the carbon offset donation can be automatically deducted from the users bank accounts and/or other financial vendor 1917 In at least some embodiments, the member can pay for the carbon offset by interacting with advertising information and/or partners (e.g., website). In at least one embodiment, a machine learning algorithm can be used to determine the organizations to which a user would like to donate 1918. In at least one embodiment, the user's preferred method of donation can be tracked and that source can be provided to the user 1918 (provide user with advertisement). In at least some embodiments, additional offset donations can be made on behalf of the user 1919. Recommendations can be provided to the user of techniques to offset the carbon footprint such as changing trip routes and/or engaging in giveback activities 1920. In at least one embodiment, giveback activities can include activities such as planting an extra tree in the user's backyard and/or volunteering for a river cleanup. In at least one embodiment, the carbon impact of engaging in a giveback activity is measured against the carbon offset of the activity. In at least one embodiment, it can be determined that engaging in the giveback activity will result in a higher carbon impact the not engaging in the giveback activity. For example if participating in the river cleanup includes the user having to drive hundred miles thereby causing 65 pounds of carbon impact while the activity itself only provides 30 pounds of carbon footprint offset then the activity can be marked as a giveback activity which is not lower the carbon offset.

In at least one embodiment, the artificial intelligence system determines which partners, listings, people, events, advertisers and/or incentives are those which the user may find interesting 1921. In at least one embodiment, of artificial intelligence system determines this based on the user's past actions and/or interactions, and/or the actions and/or interactions of users having a similar profile to the user. In at least one embodiment rewards and/or points can be redeemed upon reaching eco milestones 1922. In at least one embodiment the user can be associated with a savings accounts and/or credit card which can be used for donations to the carbon offset 1923. In at least one embodiment the credit card can provide carbon impact rewards and/or allow the carbon impact rewards to be used to pay for carbon offset.

In at least one embodiment, the member can be presented with the option to pay the carbon offset. In some embodiments, the carbon offset is automatically paid. The user can be presented with one or more organizations which money and/or time can be donated to offset the carbon footprint. The organizations can be suggested to the user based on the user profile, user cluster, and/or user behavior. In at least one embodiment the one or more organizations can include organizations which perform one or more carbon offset activities such as planting a tree on behalf of the user. In some embodiments the payment to the one or more organizations can be tax deductible and the payment information can be stored. The payment information can be exported to a tax software. In at least one embodiment the user's eco-friendly practices (i.e. performing a task of buying an energy saving appliance, paying down the carbon impact by watching advertisements, donating money to organizations, etc.) can be stored and/or used to identify potential tax benefits such as tax credits and write-offs. In some embodiments the tax credits and/or write-offs can be automatically be exported to a tax software. For example, information about a user purchasing an energy saving appliance can be exported to a tax software.

In some embodiments, reports can be created of user's carbon footprint and/or carbon offset activities. The reports can include information relevant to tax filings. In at least one embodiment ,an interface and or a module can be created to explore information to tax software, and/or other software applications. Other software applications can include applications such as conference applications, the applications of individual users can keep track of users carbon footprint while attending the conference and/or retreat. Interfaces can be created to allow the carbon footprint of individual users to be transmitted to a location only are the total carbon footprint and/or offset county calculated for the conference attendees. In some embodiments, these interfaces can be configured only transmitted of a subset of the user's data for example if the user only attended the conference Monday through Tuesday, then only the carbon footprint data per Monday through Tuesday can be transmitted.

1. A method comprising:
providing a plurality of sensors, each sensor detecting in real time one of a plurality of different real world activities and generating sensor signals therefrom indicative of said plurality of different real world activity engaged in by a user, said real world activities having an associated carbon footprint impact;
a processor receiving said sensor signals from each of said plurality of sensors and generating a user profile therefrom indicative of carbon footprint impact for each of said real world activities;
said processor communicatively coupling said sensor signals from each of said plurality of sensors to a central hub configured to communicate with a user device associated with the user, the plurality of sensors being in an environment associated with the user;
said processor using said user profile to identify a matching cluster for the user profile having characteristics similar to characteristics associated with other user profiles within said cluster;
said processor receiving a threshold time period and a carbon footprint goal representing a maximum acceptable carbon footprint impact for the user within the threshold time period;
said processor determining a user schedule within the threshold time period based on the sensor signals received from the plurality of sensors and further based upon calendar data associated with the user, wherein the user schedule includes a plurality of said real world activities engaged in by the user;
said processor using said other user profiles within said cluster to generate a data model representing relationships between the sensor signals received from sensors, and the real world activities performed by users;
said processor identifying a total predicted carbon footprint for the user schedule based on all of the sensor signals generated by said real world activities within the threshold time period, the data model, and a predicted carbon footprint for each of the said real world activities of the user schedule;
said processor determining when the total predicted carbon footprint is greater than the carbon footprint goal;
said processor identifying a task which represents a user action that is taken in connection with said real world activities of the user within the user schedule, wherein the task when performed causes the total predicted carbon footprint to decrease, and wherein determining the task includes analyzing all of the user schedule, the predicted carbon footprint for each of said real world activities of the user schedule, and the sensor signals received from the plurality of sensors; and
said processor communicating said task to the user device via the central hub.

2. The method of claim 1, wherein the calendar data is received from the user device.

3. The method of claim 2, wherein the characteristics associated with the user profile include a plurality of an age, a gender, a diet type, a home location, or a home square footage.

4. The method of claim 3, wherein the diet type is vegetarian, and the task indicates a recommendation related to a menu item.

5. The method of claim 2, wherein the sensor signals include a global positioning system (GPS) indicating a location of an automobile.

6. The method of claim 5, wherein the task indicates a recommendation to perform maintenance on the automobile.

7. The method of claim 6, comprising determining a second total predicted carbon footprint in response to the user performing the task.

8. The method of claim 7, comprising providing the user with an option to pay the second total predicted carbon footprint, the option including one or more of:
providing an advertisement;
providing a payment recommendation to pay the second total predicted carbon footprint to an organization based on the cluster with which the user profile is associated; or
providing a second payment recommendation to pay the second total predicted carbon footprint to a second organization based on a previous offset payment activity of the user

9. The method of claim 2, comprising receiving a location of the user device from a global positioning system (GPS).

10. The method of claim 9, wherein determining the user schedule includes the location of the user device.

11. The method of claim 2, comprising:
receiving a battery level of the user device;
determining the battery level is below a threshold battery level;
and determining the task to provide to the user based on the determination of the battery level being below the threshold battery level.

12. A system comprising:
a processor; and
a memory storing instructions, wherein the processor is configured to execute the instructions such that the processor and memory are configured to:
provide a plurality of sensors, each sensor detecting in real time one of a plurality of different real world activities and generating sensor signals therefrom indicative of said plurality of different real world activity engaged in by a user, said real world activities having an associated carbon footprint impact; receive said sensor signals from each of said plurality of sensors and generating a user profile therefrom indicative of carbon footprint impact for each of said real world activities;
communicatively couple said sensor signals from each of said plurality of sensors to a central hub configured to communicate with a user device associated with the user, the plurality of sensors being in an environment associated with the user;
identify, using said user profile, a matching cluster for the user profile having characteristics similar to characteristics associated with other user profiles within said cluster;
receive a threshold time period and a carbon footprint goal representing a maximum acceptable carbon footprint impact for the user within the threshold time period;
determine a user schedule within the threshold time period based on the sensor signals received from the plurality of sensors and further based upon calendar data associated with the user, wherein the user schedule includes a plurality of said real world activities engaged in by the user;
generate, using said other user profiles within said cluster, a data model representing relationships between the sensor signals received from sensors, and the real world activities performed by users;
identify a total predicted carbon footprint for the user schedule based on all of the sensor signals generated by said real world activities within the threshold time period, the data model, and a predicted carbon footprint for each of the said real world activities of the user schedule;
determine when the total predicted carbon footprint is greater than the carbon footprint goal;
identify a task which represents a user action that is taken in connection with said real world activities of the user within the user schedule, wherein the task when performed causes the total predicted carbon footprint to decrease, and wherein determining the task includes analyzing all of the user schedule, the predicted carbon footprint for each of said real world activities of the user schedule, and the sensor signals received from the plurality of sensors; and
communicate said task to the user device via the central hub.

13. The system of claim 12, wherein the calendar data is received from the user device.

14. The system of claim 13, wherein the characteristics associated with the user profile include a plurality of an age, a gender, a diet type, a home location, or a home square footage.

15. The system of claim 14, wherein the diet type is vegetarian, and the task indicates a recommendation related to a menu item.

16. The system of claim 13, wherein the sensor signals include a global positioning system (GPS) indicating a location of an automobile.

17. The system of claim 16, wherein the task indicates a recommendation to perform maintenance on the automobile.

18. The system of claim 17, wherein the processor and memory are configured to determine a second total predicted carbon footprint in response to the user performing the task.

19. The system of claim 18, the processor and memory are configured to provide the user with an option to pay the second total predicted carbon footprint, the option including one or more of:
providing an advertisement;
providing a payment recommendation to pay the second total predicted carbon footprint to an organization based on the cluster with which the user profile is associated; or
providing a second payment recommendation to pay the second total predicted carbon footprint to a second organization based on a previous offset payment activity of the user.

20. The system of claim 13, wherein the processor and memory are configured to receive a location of the user device from a global positioning system (GPS).

21. The system of claim 20, wherein determining the user schedule includes the location of the user device.

22. The system of claim 13, wherein the processor and memory are configured to receiving a battery level of the user device;
determining the battery level is below a threshold battery level;
and determining the task to provide to the user based on the determination of the battery level being below the threshold battery level.
